(19) United States
(12) Patent Application Publication
(10) Pub. No.: US 2010/0062825 A1
(43) Pub. Date: Mar. 11, 2010

(54) METHOD AND APPARATUS THAT CONTROL RISK AND UNCERTAINTY IN A PROMOTIONAL LOTTERY GAME WITH A HYBRID PRIZE STRUCTURE

(76) Inventors: Michael D. Frick, Crawfordville, FL (US); Mark Davis, San Juan, PR (US)

Correspondence Address: PATENT INGENUITY, PC, 520 BROADWAY, SUITE 350, SANTA MONICA, CA, 90401, US

(21) Appl. No.: 12/258,373

(22) Filed: Oct. 24, 2008

Related U.S. Application Data
(63) Continuation-in-part of application No. 12/254,777, filed on Oct. 20, 2008.
Application No. 12/254,777 is a continuation-in-part of application No. 12/250,270, filed on Oct. 13, 2008.
Application No. 12/250,270 is a continuation-in-part of application No. 12/206,376, filed on Sep. 8, 2008.

(51) Int. Cl. G06F 17/00

(52) U.S. Cl. 463/17

(57) ABSTRACT

A process is provided. The process generates a predetermined number of unique combinations of a set of game digits. Each of the combinations has the same quantity of digits. Further, the process prints a set of promotional lottery tickets for a promotional lottery game such that each of the promotional lottery tickets in the set of promotional lottery tickets distinctly corresponds to one of the unique combinations of the set of game digits. In addition, the process indicates a predetermined minimum number of primary prizes. The process also provides at least a subset of the set of promotional lottery tickets to a plurality of players in the promotional lottery game through ticket sales.

### RELATED APPLICATIONS

This application is a Continuation-In-Part application of U.S. patent application Ser. No. 12/254,777, filed on Oct. 20, 2008, entitled METHOD AND APARATUS THAT CONROL RISK AND UNCERTAINTY IN A VARIABLE PRICED PROMOTIONAL LOTTERY GAME, which is a Continuation-In-Part application of U.S. patent application Ser. No. 12/250,270, filed on Oct. 13, 2008, entitled METHOD AND APPARATUS THAT CONTROL RISK AND UNCERTAINTY IN A FREQUENCY PRICED RAFFLE, which is a Continuation-In-Part application of U.S. patent application Ser. No. 12/206,376, filed on Sep. 8, 2008 and entitled METHOD AND APPARATUS THAT CONTROL RISK AND UNCERTAINTY IN A RAFFLE, all of which are hereby incorporated by reference in their entireties.

### BACKGROUND

1. Field

This disclosure generally relates to the field of gaming. More particularly, the disclosure relates to a raffle game.

2. General Background

Current raffle games typically offer a pre-established number of prizes that are awarded to players in the raffle game based upon a raffle drawing in which numbers or tickets are drawn from the pool of tickets or raffle units sold. Accordingly, the aggregate cost in absolute dollars of the prizes in a given game is known before a single ticket is sold.

Traditional raffle games carry a financial risk related to marketing factors. If enough raffle tickets are not sold to cover the fixed prize costs in a traditional raffle game, profits may be much lower than expected. The traditional raffle game may produce a net loss if tickets sales volume is not enough to cover costs. In other words, if enough tickets are not sold, the cost of running the game can exceed revenues generated from ticket sales.

As an example, the quantity of total tickets or raffle units available may be one million. Further, the costs of the ticket or raffle unit may be ten dollars. A prize structure may provided that, irrespective of ticket sales, two tickets or raffle units are a match for a one million dollar prize, ten tickets or raffle units are a match for a one hundred thousand dollar prize, one hundred tickets or raffle units are a match for a ten thousand dollar prize, one thousand tickets or raffle units are a match for a one thousand dollar prize, and ten thousand tickets or raffle units are a match for a one hundred dollar prize. Accordingly, the total cost for the prizes is six million dollars. In this example, the cost of the prizes alone would require that a minimum of sixty percent of all available tickets or raffle units, i.e., six million dollars is sixty percent of ten million dollars, be sold in order to avoid a net loss.

As a result, lotteries need to sell a significantly high percentage of available tickets to provide a raffle game that offers substantial prizes and avoids the risk of a net loss. This requisite high percentage has prevented significant growth of the raffle game product segment.

### SUMMARY

In one aspect of the disclosure, a process is provided. The process generates a predetermined number of unique combinations of a set of game digits. Each of the combinations has the same quantity of digits. Further, the process prints a set of promotional lottery tickets for a promotional lottery game such that each of the promotional lottery tickets in the set of promotional lottery tickets distinctly corresponds to one of the unique combinations of the set of game digits. In addition, the process indicates a predetermined minimum number of primary prizes. The process also provides at least a subset of the set of promotional lottery tickets to a plurality of players in the promotional lottery game through ticket sales. Further, the process randomly selects, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game. In addition, the process provides each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales.

In another aspect of the disclosure, a process is provided. The process generates a predetermined number of unique combinations of a set of game digits. Each of the combinations has the same quantity of digits. Further, the process generates a predetermined number of unique sub-combinations of a set of game numbers such that each of the sub-combinations having the same quantity of numbers and randomly selecting a single subset of the set of game numbers that has the same quantity of numbers as each of the sub-combinations. In addition, the process prints a set of promotional lottery tickets for a promotional lottery game such that each of the promotional lottery tickets in the set of promotional lottery tickets corresponds to one of the unique sub-combinations of a set of game numbers and distinctly corresponds to one of the unique combinations of the set of game digits. The process also indicates a predetermined minimum number of primary prizes. Further, the process indicates a plurality of secondary prizes. Each of the secondary prizes in the plurality of secondary prizes has a lesser value than each of the predetermined minimum number of primary prizes. In addition, the process provides at least a subset of the set of promotional lottery tickets to a plurality of players in the promotional lottery game through ticket sales. The process also randomly selects, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game. Further, the process randomly selects a single subset of the set of game numbers that has the same quantity of numbers as each of the sub-combinations. In addition, the process provides each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales. Finally, the process provides a secondary prize from the plurality of secondary prizes to a player based on a type of match on a promotional lottery ticket of the player between the unique sub-combination corresponding to the promotional lottery ticket and the single subset of the set of game numbers that is selected.

In yet another aspect of the disclosure, a system is provided. The system includes a combination generation module that generates a predetermined number of unique combinations of a set of game digits. Each of the combinations has the same quantity of digits. Further, the system includes a printer that prints a set of promotional lottery tickets for a promotional lottery game such that each of the promotional lottery tickets in the set of promotional lottery tickets distinctly corresponds to one of the unique combinations of the set of game digits. In addition, the system includes a display module that indicates a predetermined minimum number of primary prizes. The system also includes a ticket distribution module that provides at least a subset of the set of promotional lottery tickets to a plurality of players in the promotional lottery game through ticket sales. The system also includes a random selection module that randomly selects, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game. Finally, the system includes a primary prize distribution module that provides each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales.

In another aspect of the disclosure, a system is provided. The system includes a combination generation module that generates a predetermined number of unique combinations of a set of game digits. Each of the combinations has the same quantity of digits. Further, the system includes a sub-combination module that generates a predetermined number of unique sub-combinations of a set of game numbers such that each of the sub-combinations having the same quantity of numbers and randomly selecting a single subset of the set of game numbers that has the same quantity of numbers as each of the sub-combinations. In addition, the system includes a printer that prints a set of promotional lottery tickets for a promotional lottery game such that each of the promotional lottery tickets in the set of promotional lottery tickets corresponds to one of the unique sub-combinations of a set of game numbers and distinctly corresponds to one of the unique combinations of the set of game digits. The system also includes a display module that a predetermined minimum number of primary prizes and a plurality of secondary prizes. Each of the secondary prizes in the plurality of secondary prizes having a lesser value than each of the predetermined minimum number of primary prizes. Further, the system includes a ticket distribution module that provides at least a subset of the set of promotional lottery tickets to a plurality of players in the promotional lottery game through ticket sales. In addition, the system includes a primary prize random selection module that randomly selects, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game. The system also includes a secondary prize random selection module that randomly selects a single subset of the set of game numbers that has the same quantity of numbers as each of the sub-combinations. Further, the system includes a primary prize distribution module that provides each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales. Finally, the system includes a secondary prize distribution module that provides a secondary prize from the plurality of secondary prizes to a player based on a type of match on a promotional lottery ticket of the player between the unique sub-combination corresponding to the promotional lottery ticket and the single subset of the set of game numbers that is selected.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a probabilities-based raffle prize structure.

FIG. 2 illustrates a probabilities-based raffle prize structure that is an alternative configuration of the probabilities-based raffle prize structure illustrated in FIG. 1.

FIG. 3 illustrates a process that may be utilized to provide a probabilities-based raffle game.

FIG. 4 illustrates a block diagram of a station or system that composes and provides a probabilities-based raffle game.

FIG. 5 illustrates a frequency priced display. The frequency price display includes a price field and a predetermined quantity field.

FIG. 6 illustrates a process that may be utilized in a frequency based raffle.

FIG. 7 illustrates a process that may be utilized with a pari-mutuel based secondary prize.

FIG. 8 illustrates a process that may be utilized to provide a subsequent random selection.

FIG. 9 illustrates a process that may be utilized as an alternative to the process illustrated in FIG. 7.

FIG. 10 illustrates a promotional lottery prize structure.

FIG. 11 illustrates a promotional lottery prize structure that is an alternative configuration of the promotional lottery prize structure illustrated in FIG. 10.

FIG. 12 illustrates process that may be utilized to provide a promotional lottery game.

FIG. 13 illustrates a process that may be utilized in a frequency priced promotional lottery game.

FIG. 14 illustrates a promotional lottery prize structure with a variable price.

FIG. 15 illustrates an example of a display of price levels for the variable price corresponding to predetermined maximum prize thresholds.

FIG. 16 illustrates a process that may be utilized to provide a variable pricing with promotional lottery tickets.

FIG. 17 illustrates a process that utilizes variable pricing with frequency multiple pricing.

FIG. 18 illustrates a process that may be utilized with variable pricing.

FIG. 19 illustrates a promotional lottery prize structure with a predetermined minimum number of primary prizes and a plurality of secondary prizes.

FIG. 20 illustrates a display of the odds as the number of primary prizes stays constant and then changes.

FIG. 21 illustrates an example of a promotional lottery ticket.

FIG. 22 illustrates a process that may be utilized to implement multiple primary prizes.

FIG. 23 illustrates a promotional lottery prize structure.

FIG. 24 illustrates another process that utilized to implement multiple primary prizes.

FIG. 25 illustrates an example of a promotional lottery ticket.

### DETAILED DESCRIPTION

A method and apparatus are disclosed that provide a probabilities-based prize structure in a raffle game. The probabilities-based prize structure provides a known universe of prizes that would be awarded if all raffle tickets are sold. However, the awarding of prizes and the number of prizes is randomly determined based upon probabilities and odds regardless of the volume of tickets or units sold. In contrast to a lottery game, in one configuration, the raffle game would not provide for sharing of a prize in the event of multiple winners. In further contrast to a lottery game, in one configuration, the raffle game would not allow for rollovers, i.e., prizes amounts that have not been won in a particular drawing are not available for subsequent drawings.

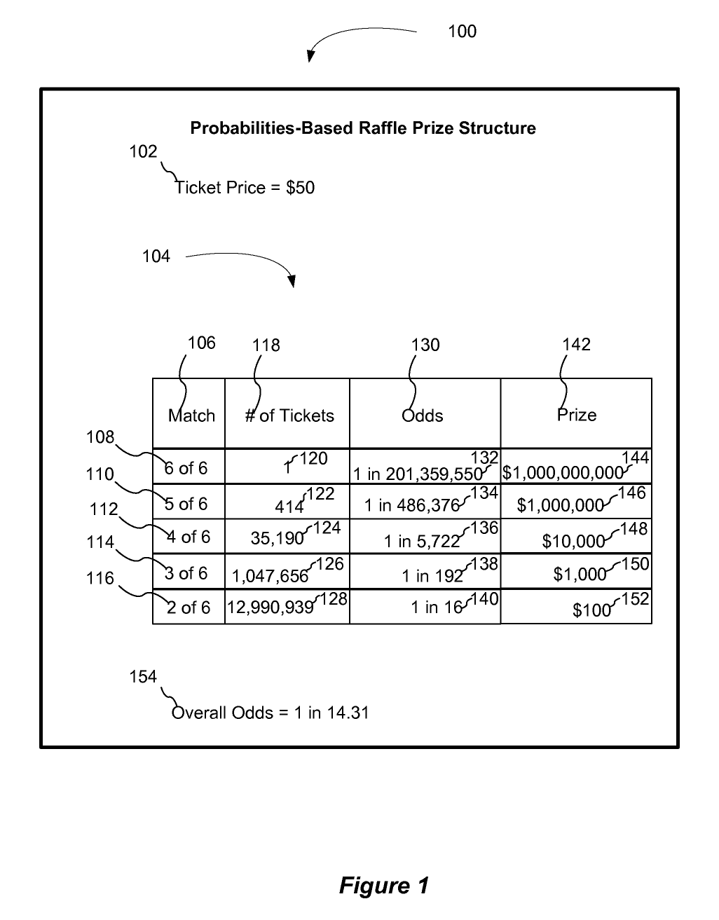

FIG. 1 illustrates a probabilities-based raffle prize structure 100. As an example, the ticket price 102 for a probabilities-based raffle ticket may be fifty dollars. A payout table 104 indicates the various prizes corresponding to particular types of matches between a set of player numbers appearing on a probabilities-based raffle ticket and a set of game numbers drawn in a drawing. A match field 106 indicates the different types of matches. For example, the match field 106 indicates a six of six match 108, a five of six match 110, a four of six match 112, a three of six match 114, and a two of six match 116.

Further, a number of tickets 118 is indicated for each of the matches. For example, a six of six number of ticket field 122 indicates that one hundred tickets out of all the available tickets, e.g., two hundred one million three hundred fifty nine five hundred fifty tickets, have a winning six of six match. Further, a five of six number of tickets field 124 indicates that four hundred fourteen tickets out of all the available tickets, e.g., two hundred one million three hundred fifty nine five hundred fifty tickets, have a winning five of six match. In addition, a four of six number of tickets field 124 indicates that thirty five thousand one hundred ninety tickets out of all the available tickets, e.g., two hundred one million three hundred fifty nine five hundred fifty tickets, have a winning four of six match. A three of six number of tickets field 128 indicates that one million forty seven six hundred fifty six tickets out of all the available tickets, e.g., two hundred one million three hundred fifty nine five hundred fifty tickets, have a winning three of six match. Further, a two of six number of tickets field 130 indicates that twelve million nine hundred ninety thousand nine hundred thirty nine tickets out of all the available tickets, e.g., two hundred one million three hundred fifty nine five hundred fifty tickets, have a winning two of six match.

An odds field 130 is also displayed. For example, a six of six odds field 132 indicates that the odds of having a six of six match are one in two hundred one million three hundred fifty nine five hundred fifty. Further, a five of six odds field 134 indicates that the odds of having a five of six match are one in four hundred eighty six thousand three hundred seventy six. In addition, a four of six odds field 136 indicates that the odds of having a four of six match are one in five thousand seven hundred twenty two. A three of six odds field 138 indicates that the odds of having a three of six match are one in one hundred ninety two. Further, a two of six odds field 140 indicates that the odds of having a two of six match are one in sixteen.

A prize field is also displayed. For example, a six of six match prize field 144 indicates that a prize of one billion dollars is won for a full match of six of six. Further, a five of six match prize field 146 indicates that a secondary prize of one million dollars is won for a partial match of five of six. If all four hundred fourteen tickets with five of six matches are sold, the secondary prize of one million dollars is provided in its entirety to each individual player. In one embodiment, the entirety of the prize may be provided as an annuity over time, a cash lump sum, or a discounted cash lump sum. In addition, a four of six match prize field 148 indicates that a prize of ten thousand dollars is won for a partial match of four of six. A three of six match prize field 150 indicates that a prize of one thousand dollars is won for a partial match of three of six. Finally, a two of six match prize field 152 indicates that a prize of one hundred dollars is won for a partial match of two of six. In one embodiment, the overall odds 154 of winning any type of prize may be displayed. For example, the overall odds 154 may be one in fourteen and thirty one tenths.

Unlike a typical raffle game, the probabilities-based raffle game randomly selects a winning ticket that may not have been sold. In other words, a typical raffle game selects a winning ticket from the tickets that are sold. As a result, all the prizes have to be paid out irrespective of whether ticket sales are enough for the payment of the prizes. The probabilities-based raffle game provides all the prizes if all the probabilities-based raffle game tickets are sold. However, if all of the probabilities-based raffle game tickets are not sold, the probabilities-based raffle game may not provide all the prizes. The probabilities-based raffle game randomly selects winning tickets from all possible tickets, not from all tickets sold. In one embodiment, the random selection may be implemented through a drawing of numbers. For example, a ball hopper, a random number generator, etc. may be utilized. As an example, a hopper may have seventy five balls from which six balls are drawn to obtain the six numbers that are utilized to determine potential matches illustrated in FIG. 1. In another embodiment, the drawing is a single drawing.

The term expected payout percentage is intended to indicate the expected payout of a prize category as a percentage of ticket sales. The mathematically expected payout percentage can be derived for each prize category assuming all tickets are sold. For example, if all two hundred one million three hundred fifty nine five hundred fifty tickets are sold, the gross ticket sales equal ten billion sixty seven million nine hundred seventy seven thousand five hundred dollars. Therefore, the expected payout percentage for the maximum prize of one billion dollars, if paid as a cash lump sum prize, in the six of six match prize category equals nine and nine tenths percent.

Further, an analysis may be performed according to different ticket sales intervals to assess risk. For example, the expected payout percentage for the maximum prize category can be determined on the assumption that only thirty percent of the available tickets are sold. As a result, an entity can determine the risk level of different potential ticket sales. The analysis may also be performed for secondary prize categories.

In one embodiment, a secure process of random ticket distribution is utilized. Accordingly, a change in ticket sales should not substantially change the expected payout percentage for the lower prize categories. In other words, the higher number of prizes and the lower prizes in the lower prize categories prevents a substantial change in expected payout percentage for a moderate or even somewhat significant change in the ticket sales.

The mathematically expected payout percentage can also be derived for a subset or all of the prize categories assuming all tickets are sold. Further, an analysis may be performed according to different ticket sales intervals to assess risk.

The probabilities-based prize structure 100 allows volume-sensitive ticket pricing to be utilized to provide appealing prizes based upon a mathematically expected minimum payout percentage. The mathematically expected minimum payout creates a buffer for relatively low sales volumes. For example, a prize structure could be developed to allow for a fifty percent expected payout percentage if less than thirty percent of total tickets are sold. Similarly, a prize structure could be developed to permit a sixty five percent payout if less than twenty percent of all tickets are sold.

In one embodiment, a percentage of ticket sales may be redistributed to the secondary prize categories. For example, if three quarters of the available tickets are sold without a six of six match, a percentage of the ticket sales can redistributed to increase the secondary prizes. As an example, the five of six match prize 146 may be increased to two million dollars. Accordingly, the secondary prizes are guaranteed minimums that may be increased based on ticket sales volume. In another embodiment, the secondary prizes may be increased even if the maximum prize is won.

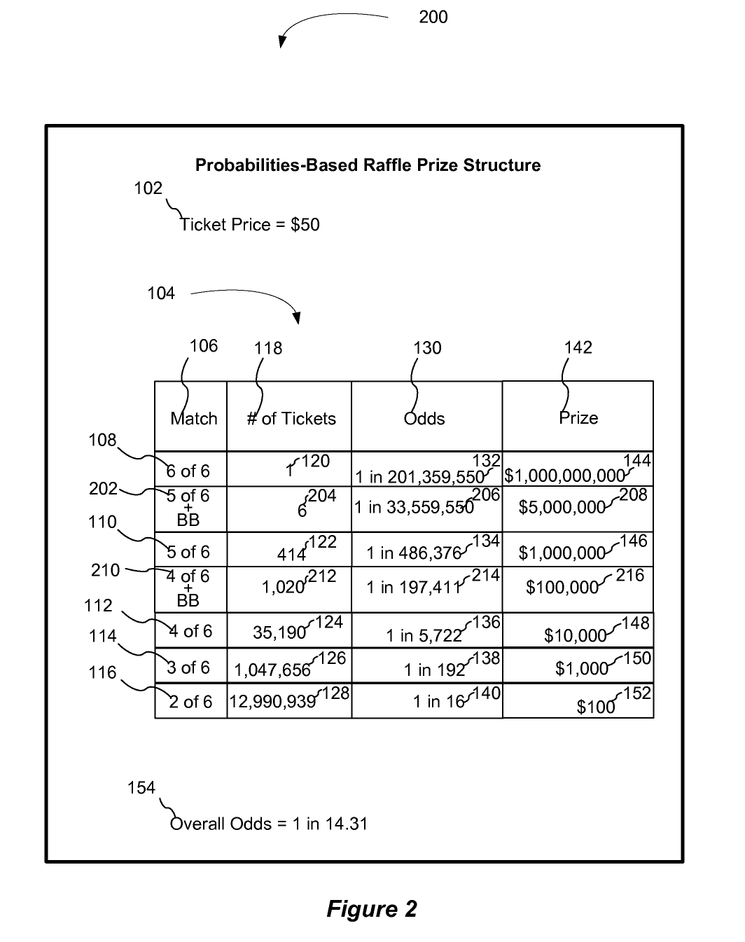

FIG. 2 illustrates a probabilities-based raffle prize structure 200 that is an alternative configuration of the probabilities-based raffle prize structure 100 illustrated in FIG. 1. The probabilities-based raffle prize structure 200 may utilize a bonus ball (“BB”) in addition to regular balls. In other words, six numbers are drawn, and then an additional BB is drawn. In one embodiment, that BB is simply one of the remaining balls, e.g., one of the remaining sixty nine balls out of seventy five balls in a hopper. In another embodiment, the BB is a ball drawn from a separate hopper. In yet another embodiment, the BB has a different indicia other than a number such as a color or a shape.

Accordingly, the probabilities-based raffle prize structure 200 has additional prizes for BB possibilities. For example, a five of six plus BB match field indicates a five of six plus BB match. Further, a five of six plus BB number of tickets field 204 indicates that six tickets have the winning five of six plus BB match. In addition, a five of six plus BB match odds field 206 indicates that the odds of winning the five of six plus BB match prize are one in thirty three million five hundred fifty nine thousand five hundred fifty. Finally, a five of six plus BB match prize field 208 indicates that a five of six plus BB match prize of five million dollars may be won with a partial match of five of six plus BB match. As another example, a four of six plus BB match field 210 indicates a four of six plus BB match. Further, a four of six plus BB number of tickets field 212 indicates that one thousand twenty tickets have the winning four of six plus BB match. In addition, a four of six plus BB match odds field 214 indicates that the odds of winning the four of six plus BB match prize are one in one hundred ninety seven thousand four hundred eleven. Finally, a four of six plus BB match prize field 216 indicates that a four of six plus BB match prize of one hundred thousand dollars may be won with a partial match of five of six plus BB match.

In an alternative embodiment, the probabilities-based raffle game may be supplemented with instant prizes to deliver value to players in advance of the raffle drawing. Unlike the probabilities-based prizes that are awarded in the raffle drawing itself, the instant prizes would be awarded at predetermined intervals or in predetermined quantities of tickets or defined subsets of tickets to be sold. The instant prizes may be utilized with any of the processes or system described herein.

In another embodiment, the probabilities-based raffle game may be supplemented with early bird prizes intended to deliver greater value to players who purchase tickets early in the sales cycle. The additional early bird drawings could be conducted prior to the main raffle drawing. Players who purchase tickets at the beginning of the sales cycle would have progressively more chances to win early bird prizes. Further, players who purchase tickets later in the sales cycle would have progressively fewer chances to win early bird prizes. A unique identified or ticket number may be assigned to each unit sold for purposes of determining winners in the early bird drawings. The early bird prizes may be utilized with any of the processes or system described herein.

In yet another embodiment, the probabilities-based raffle game may include multiple prices for different portions of potential prize distributions. For example, a twenty five dollar ticket may allow a winner to win only forty percent of the six of six match prize 144 whereas a fifty dollar ticket may allow a winner to win one hundred percent of the six of six match prize 144. Therefore, the player is incentivized to purchase a fifty dollar ticket rather than two twenty five dollar tickets as the fifty dollar ticket provides a higher prize than two twenty five dollar tickets.

In another embodiment, the multiple pricing is directed towards price-volume discounts. For example, twenty five dollars may allow a player to purchase a single ticket whereas one hundred dollars may allow a player to purchase five tickets. Therefore, the player is incentivized to purchase five tickets for one hundred dollars rather than four individual tickets as the five tickets provide more opportunities to win a prize than four individual tickets for the same total price of one hundred dollars.

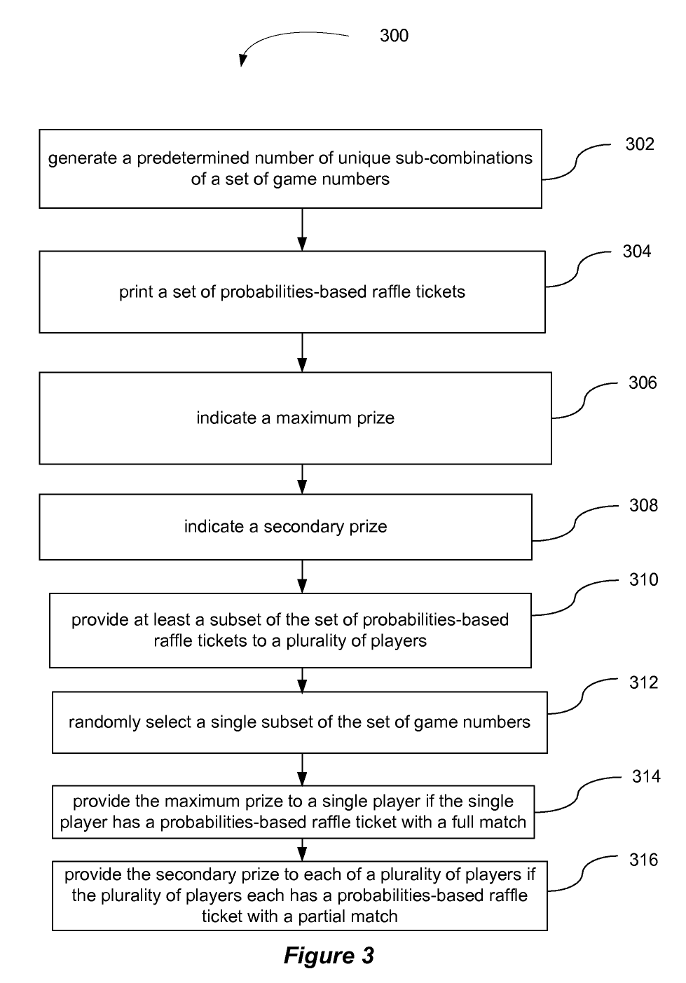

FIG. 3 illustrates a process 300 that may be utilized to provide a probabilities-based raffle game. At a process block 302, the process 300 generates a predetermined number of unique sub-combinations of a set of game numbers. Each of the sub-combinations has the same quantity of numbers. Further, at a process block 304, the process 300 prints a set of probabilities-based raffle tickets for a probabilities-based raffle game such that each of the probabilities-based raffle tickets in the set of probabilities-based raffle tickets distinctly corresponds to one of the unique sub-combinations of the set of game numbers. In addition, at a process block 306, the process 300 indicates a maximum prize that a single player having a probabilities-based raffle ticket with a full match wins. At a process block 308, the process 300 also indicates a secondary prize that each of a plurality of players having a probabilities-based raffle ticket with a partial match wins. Each partial match is distinct and has a same quantity of numbers matched. At a process block 310, the process 300 also provides at least a subset of the set of probabilities-based raffle tickets to a plurality of players in the probabilities-based raffle game. Further, at a process block 312, the process 300 randomly selects a single subset of the set of game numbers that has the same quantity of numbers as each of the sub-combinations. In addition, at a process block 314, the process 300 provides the maximum prize to a single player if the single player has a probabilities-based raffle ticket with a full match between the unique sub-combination corresponding to the probabilities-based raffle ticket and the single subset of the set of game numbers that is selected. At a process block 316, the process 300 also provides the secondary prize to each of a plurality of players if the plurality of players each has a probabilities-based raffle ticket with a partial match between the unique sub-combination corresponding to the probabilities-based raffle ticket and the single subset of the set of game numbers that is selected.

In one embodiment, the process 300 also establishes, prior to the providing the at least the subset of the set of probabilities-based raffle tickets to the plurality of players in the probabilities-based raffle game, a predetermined percentage of tickets sales to be paid in prizes won for the probabilities-based raffle game. For example, a lottery may determine that fifty percent of tickets sales have to be utilized for paying prizes. Accordingly, the process 300 may increase the secondary prize by an additional amount if the total percentage of actual ticket sales subtracted from the predetermined percentage of ticket sales results in a remainder. The additional amount is less than or equal to the remainder. In the example with the predetermined percentage of fifty percent, if the total percentage of actual ticket sales is only forty percent, a remainder of ten percent exists. A portion or potentially all of that remainder may be utilized to increase the secondary prize. Further, that remainder may be split amongst multiple secondary prizes. In one configuration, the split within a prize category is even, but the split amongst different prize categories may be weighted. In one embodiment, the increase of the secondary prize by the percentage of ticket sales is effectuated prior to the random selection of the single subset of the set of game numbers that has the same quantity of numbers as each of the sub-combinations. In another embodiment, the increase of the secondary prize by the percentage of ticket sales is effectuated after the random selection of the single subset of the set of game numbers that has the same quantity of numbers as each of the sub-combinations. Further, in one embodiment, non-payment of the maximum prize is a criterion for the increasing the secondary prize by the percentage of ticket sales. In the example, less than fifty percent of tickets would have to be sold and the maximum prize would not be won by any of the sold tickets in order for the secondary prize to be increased.

In one embodiment, the process 300 randomly selects an unordered sub-combination of a set of game numbers. For example, if the drawn sub-combination is the set of six of seventy five numbers equaling ten, twenty, thirty, forty, fifty, and sixty, a ticket holder can have those numbers in any order and win the maximum prize.

In an alternative embodiment, the process 300 selects an ordered sub-combination of a set of game numbers. For example, one hundred million tickets may be distributed. The tickets may be numbered zero through ninety nine million nine hundred ninety nine thousand nine hundred ninety nine. Each of eight digits would have to be matched in the correct order to be a winning ticket. For example, if the selected winning number is thirty one million one hundred seventy thousand five hundred ninety one six hundred fifty eight, the maximum prize winner has each of the digits on the ticket in the same order as selected. In other words, the number thirty one million one hundred fifty thousand seven hundred ninety one six hundred fifty eight has the same numbers as the selected number, but in a different order and therefore does not win the maximum prize. In one embodiment, the secondary prizes are based on having a whole number after the beginning digits. For example, the number seventy one million one hundred seventy thousand five hundred ninety one six hundred fifty eight is a seven of eight match because the first digit was not a match, but the remaining seven digits were in the identical order positions of the digits in the selected number. In one embodiment, a predetermined percentage of tickets sales to be paid in prizes won for the probabilities-based raffle game may also be established. For example, fifty percent of ticket sales may have to be paid in prizes that are won. The secondary prizes may be increased as described above if a remainder exists.

In another embodiment, the process 300 utilizes a drawing for raffle prizes as a ratio of odds to units sold. The number of secondary prizes actually distributed is based on the direct proportion of odds to units sold. In another configuration, a winning ticket may not have to have an ordered match of drawn numbers. For example, if a raffle has one million tickets, the odds of winning the maximum prize are one in one million. That prize amount is static. However, the odds of winning a secondary prize with ten thousand tickets in the one million tickets may be one in one hundred. If only fifty percent of tickets are sold, then the number of prizes that are distributed is only five thousand, i.e., the total number of secondary prizes is divided in half. Even though the number of secondary prizes is reduced by this proportion, each of those secondary prizes may be increased by an additional amount of a remainder that may exist as described above. In one configuration, a winning ticket has to have an ordered match of drawn numbers.

The term maximum prize is defined herein to be the highest amount of a prize that may be won for an instant lottery game corresponding to an instant lottery ticket. Further, the term secondary prize is defined herein to be an amount of a prize less than the maximum that may be won for an instant lottery game corresponding to an instant lottery ticket. The secondary prize may be a prize that is the next lowest prize amount after the maximum prize or may be a prize that has a lower amount than the maximum prize and other prizes. In one embodiment, the process 300 may be utilized for more a maximum prize and a plurality of different secondary prizes that each have different prize amounts.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network.

A computer is herein intended to include any device that has a general, multi-purpose or single purpose processor as described above. For example, a computer may be a lottery terminal, a kiosk, a vending machine, a set top box (“STB”), cell phone, portable media player, or the like.

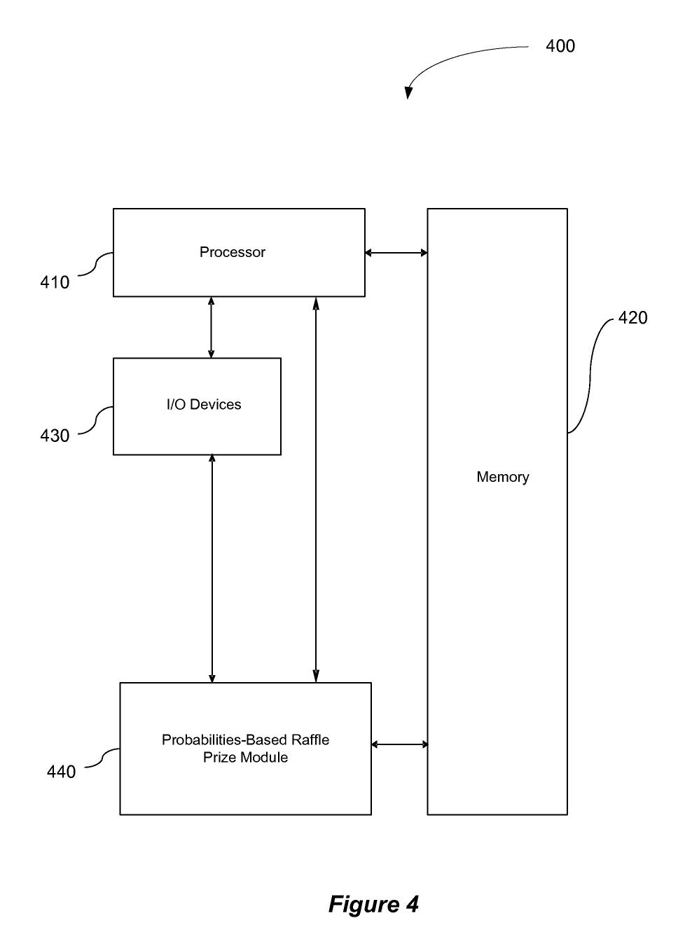

FIG. 4 illustrates a block diagram of a station or system 400 that composes and provides a probabilities-based raffle game. In one embodiment, the station or system 400 is implemented utilizing a general purpose computer or any other hardware equivalents. Thus, the station or system 400 comprises a processor 410, a memory 420, e.g., random access memory (“RAM”) and/or read only memory (ROM), a probabilities-based raffle prize module 440, and various input/output devices 430, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the probabilities-based raffle prize module 440 may be implemented as one or more physical devices that are coupled to the processor 410. For example, the probabilities-based raffle prize module 440 may include a plurality of modules. Alternatively, the probabilities-based raffle prize module 440 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor in the memory 420 of the computer. As such, the probabilities-based raffle prize module 440 (including associated data structures) of the present disclosure may be stored on a computer readable medium, e.g., RAM memory, magnetic or optical drive or diskette and the like.

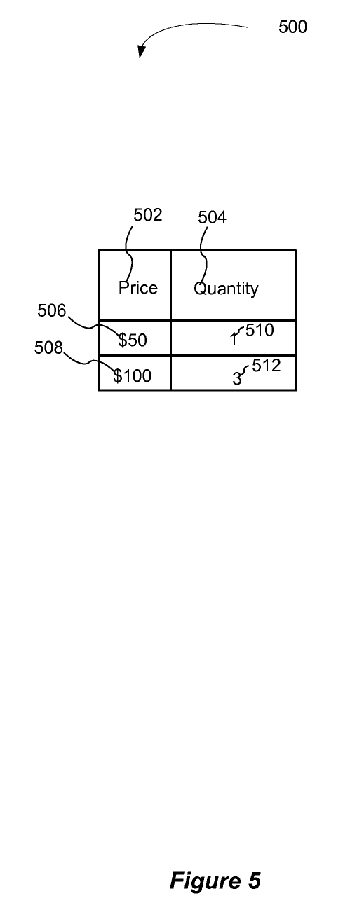

Any of the configurations discussed above may be utilized with a frequency priced raffle. In other words, a player may purchase a larger quantity of tickets for a higher price. FIG. 5 illustrates a frequency priced display 500. The frequency price display 500 includes a price field 502 and a predetermined quantity field 504. The price field 502 may include a first price category 506 and a second price category 508. Further, the quantity field 504 may include a first predetermined quantity 510 that corresponds to the first price category 506 and a predetermined second quantity 512 that corresponds to the second price category 508. As an example, the first price category 506 may be fifty dollars and the first predetermined quantity 510 may be one ticket. Further, the second price category 508 may be one hundred dollars and the second predetermined quantity 512 may be three tickets. Accordingly, a ratio of the second price category to the second predetermined quantity of one or more probabilities-based raffle tickets is less than a ratio of the first price category to the first predetermined quantity of one or more probabilities-based raffle tickets. In other words, the ratio of one hundred dollars to three tickets is less than the ratio of fifty dollars to one ticket. As a result, a player is incentivized to purchase a group of three tickets for one hundred dollars rather than purchase three individual tickets separately for a total of one hundred fifty dollars.

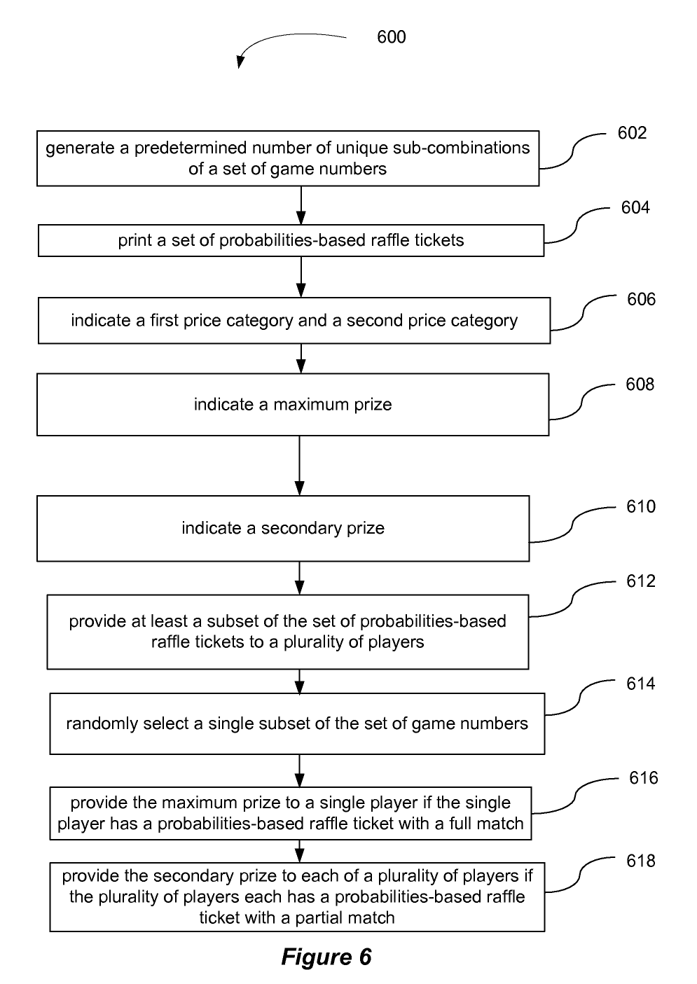

FIG. 6 illustrates a process 600 that may be utilized in a frequency based raffle. At a process block 602, the process 600 generates a predetermined number of unique sub-combinations of a set of game numbers. Each of the sub-combinations having the same quantity of numbers. Further, at a process block 604, process 600 prints a set of probabilities-based raffle tickets for a probabilities-based raffle game such that each of the probabilities-based raffle tickets in the set of probabilities-based raffle tickets distinctly corresponds to one of the unique sub-combinations of the set of game numbers. In addition, at a process block 606, the 600 process indicates a first price category and a second price category from which one or more probabilities-based raffle tickets can be purchased such that (i) the first price category corresponds to a first predetermined known quantity of one or more probabilities-based raffle tickets and the second price category corresponds to a second predetermined known quantity of one or more probabilities-based raffle tickets and (ii) a ratio of the second price category to the second predetermined quantity of one or more probabilities-based raffle tickets is less than a ratio of the first price category to the first predetermined quantity of one or more probabilities-based raffle tickets. At a process block 608, the process 600 also indicates a maximum prize that is won by a player having a probabilities-based raffle ticket with a full match. Further, at a process block 610 the process indicates a secondary prize that is won by a player having a probabilities-based raffle ticket with a partial match. In addition, at a process block 612, the process 600 provides at least a subset of the set of probabilities-based raffle tickets to a plurality of players in the probabilities-based raffle game. At a process block 614, the process 600 also randomly selects a single subset of the set of game numbers that has the same quantity of numbers as each of the sub-combinations. Further, at a process block 616, the process 600 provides the maximum prize to a player if the player has a probabilities-based raffle ticket with a full match between the unique sub-combination corresponding to the probabilities-based raffle ticket and the single subset of the set of game numbers that is selected. In addition, at a process block 618, the process 600 provides the secondary prize to a player if the player has a probabilities-based raffle ticket with a partial match between the unique sub-combination corresponding to the probabilities-based raffle ticket and the single subset of the set of game numbers that is selected.

The station or system 400 described herein may be utilized to implement the process 600 in a hardware configuration. Modules may be utilized to implement software and/or hardware components in the station or system 400.

In any of the configurations provided herein, the secondary prize may be pari-mutuel based. In other words, the secondary prize may be based on a portion of ticket sales. Accordingly, an indication of the secondary prize may be an estimate. In other words, the actual secondary prize that is distributed may be the exact estimate, less than the estimate, or greater than the estimate.

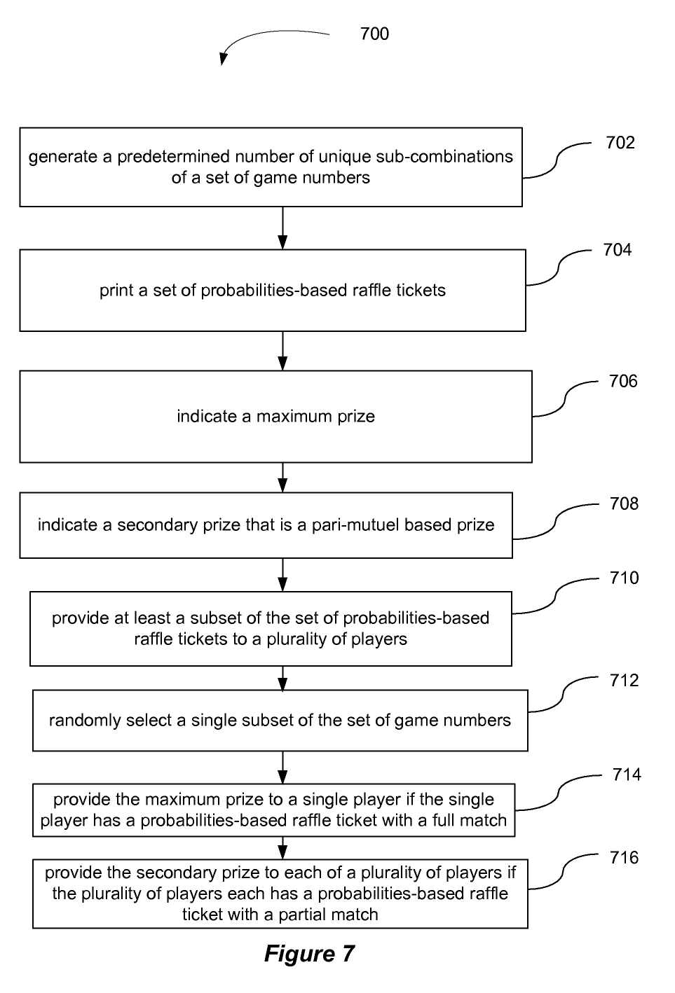

FIG. 7 illustrates a process 700 that may be utilized with a pari-mutuel based secondary prize. At a process block 702, the process 700 generates a predetermined number of unique sub-combinations of a set of game numbers. Each of the sub-combinations has the same quantity of numbers. Further, at a process block 704, the process 700 prints a set of probabilities-based raffle tickets for a probabilities-based raffle game such that each of the probabilities-based raffle tickets in the set of probabilities-based raffle tickets distinctly corresponds to one of the unique sub-combinations of the set of game numbers. In addition, at a process block 706, the process 700 indicates a maximum prize that a single player having a probabilities-based raffle ticket with a full match wins. At a process block 708, the process 700 also indicates a secondary prize that is a pari-mutuel based prize based on a predetermined portion of ticket sales. The secondary prize is won by a player having a probabilities-based raffle ticket with a partial match. At a process block 710, the process 700 also provides at least a subset of the set of probabilities-based raffle tickets to a plurality of players in the probabilities-based raffle game. Further, at a process block 712, the process 700 randomly selects a single subset of the set of game numbers that has the same quantity of numbers as each of the sub-combinations. In addition, at a process block 714, the process 700 provides the maximum prize to a single player if the single player has a probabilities-based raffle ticket with a full match between the unique sub-combination corresponding to the probabilities-based raffle ticket and the single subset of the set of game numbers that is selected. At a process block 716, the process 700 also provides the secondary prize to each of a plurality of players if the plurality of players each has a probabilities-based raffle ticket with a partial match between the unique sub-combination corresponding to the probabilities-based raffle ticket and the single subset of the set of game numbers that is selected.

The station or system 400 described herein may be utilized to implement the process 700 in a hardware configuration. Modules may be utilized to implement software and/or hardware components in the station or system 400.

In any of the configurations discussed above, the maximum prize may not be won in an initial random selection such as an initial drawing. For example, if thirty percent of the tickets are sold, the ticket with the full match may potentially be in the seventy percent of the tickets that were not sold. In one embodiment, a subsequent random selection such as a subsequent drawing may be performed from the sets of numbers on the tickets that were sold to ensure a full match winner for the maximum prize.

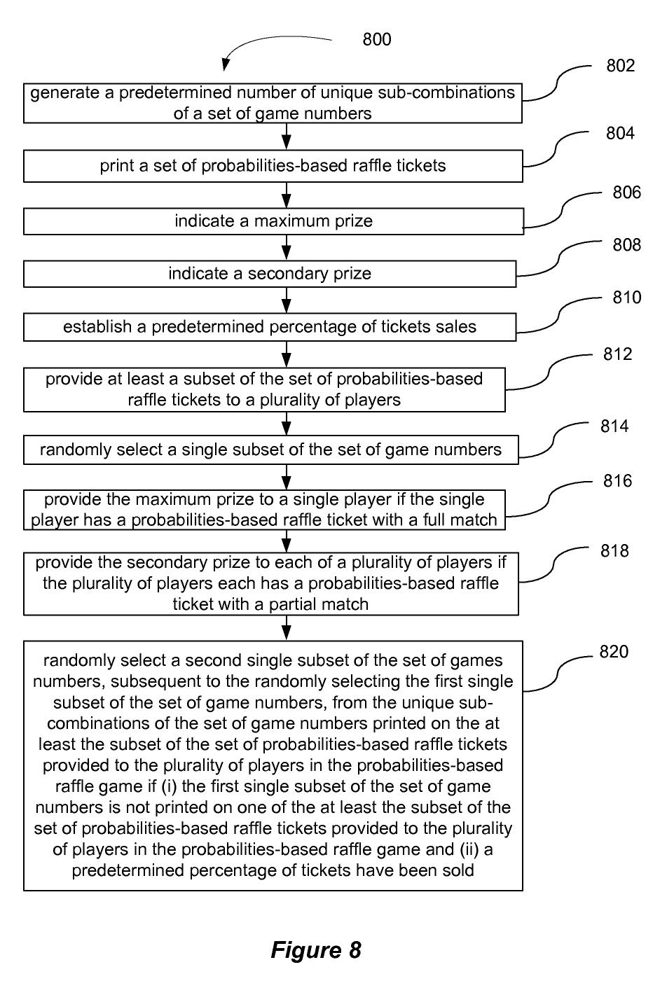

FIG. 8 illustrates a process 800 that may be utilized to provide a subsequent random selection. At a process block 802, the process 800 generates a predetermined number of unique sub-combinations of a set of game numbers. Each of the sub-combinations has the same quantity of numbers. Further, at a process block 804, the process 800 prints a set of probabilities-based raffle tickets for a probabilities-based raffle game such that each of the probabilities-based raffle tickets in the set of probabilities-based raffle tickets distinctly corresponds to one of the unique sub-combinations of the set of game numbers. In addition, at a process block 806, the process 800 indicates a maximum prize that a single player having a probabilities-based raffle ticket with a full match wins. At a process block 808, the process 800 also indicates a secondary prize that each of a plurality of players having a probabilities-based raffle ticket with a partial match wins. Each partial match is distinct and has a same quantity of numbers matched. At a process block 810, the process 800 establishes a predetermined percentage of tickets sales to be paid in prizes won for the probabilities-based raffle game. At a process block 812, the process 800 also provides at least a subset of the set of probabilities-based raffle tickets to a plurality of players in the probabilities-based raffle game. Further, at a process block 814, the process 800 randomly selects a single subset of the set of game numbers that has the same quantity of numbers as each of the sub-combinations. In addition, at a process block 816, the process 800 provides the maximum prize to a single player if the single player has a probabilities-based raffle ticket with a full match between the unique sub-combination corresponding to the probabilities-based raffle ticket and the single subset of the set of game numbers that is selected. At a process block 818, the process 800 also provides the secondary prize to each of a plurality of players if the plurality of players each has a probabilities-based raffle ticket with a partial match between the unique sub-combination corresponding to the probabilities-based raffle ticket and the single subset of the set of game numbers that is selected. Finally, at a process block 820, the process 800 randomly selects a second single subset of the set of games numbers, subsequent to the randomly selecting the first single subset of the set of game numbers, from the unique sub-combinations of the set of game numbers printed on the at least the subset of the set of probabilities-based raffle tickets provided to the plurality of players in the probabilities-based raffle game if (i) the first single subset of the set of game numbers is not printed on one of the at least the subset of the set of probabilities-based raffle tickets provided to the plurality of players in the probabilities-based raffle game and (ii) a predetermined percentage of tickets have been sold. In one embodiment, the predetermined percentage of tickets that have to be sold is determined by meeting a lottery's profit criteria.

The station or system 400 described herein may be utilized to implement the process 800 in a hardware configuration. Modules may be utilized to implement software and/or hardware components in the station or system 400.

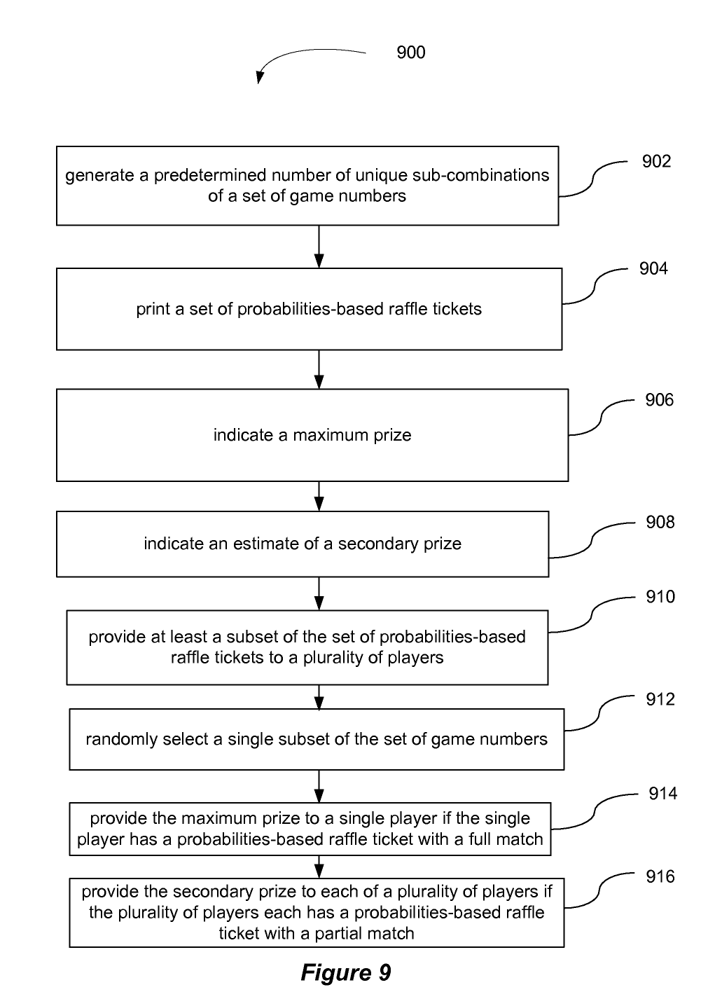

FIG. 9 illustrates a process 900 that may be utilized as an alternative to the process 700 illustrated in FIG. 7. At a process block 902, the process 900 generates a predetermined number of unique sub-combinations of a set of game numbers. Each of the sub-combinations has the same quantity of numbers. Further, at a process block 904, the process 900 prints a set of probabilities-based raffle tickets for a probabilities-based raffle game such that each of the probabilities-based raffle tickets in the set of probabilities-based raffle tickets distinctly corresponds to one of the unique sub-combinations of the set of game numbers. In addition, at a process block 906, the process 900 indicates a maximum prize that a single player having a probabilities-based raffle ticket with a full match wins. At a process block 908, the process 900 also indicates an estimate of a secondary prize. The secondary prize is won by a player having a probabilities-based raffle ticket with a partial match. At a process block 910, the process 900 also provides at least a subset of the set of probabilities-based raffle tickets to a plurality of players in the probabilities-based raffle game. Further, at a process block 912, the process 900 randomly selects a single subset of the set of game numbers that has the same quantity of numbers as each of the sub-combinations. In addition, at a process block 914, the process 900 provides the maximum prize to a single player if the single player has a probabilities-based raffle ticket with a full match between the unique sub-combination corresponding to the probabilities-based raffle ticket and the single subset of the set of game numbers that is selected. At a process block 916, the process 900 also provides the secondary prize to each of a plurality of players if the plurality of players each has a probabilities-based raffle ticket with a partial match between the unique sub-combination corresponding to the probabilities-based raffle ticket and the single subset of the set of game numbers that is selected.

The station or system 400 described herein may be utilized to implement the process 900 in a hardware configuration. Modules may be utilized to implement software and/or hardware components in the station or system 400.

The configurations and prize structures described above are not limited to a probabilities-based raffle game. For example, any of the configurations and prize structures described above may be utilized with a lottery game. In one embodiment, the lottery game is a promotional lottery game.

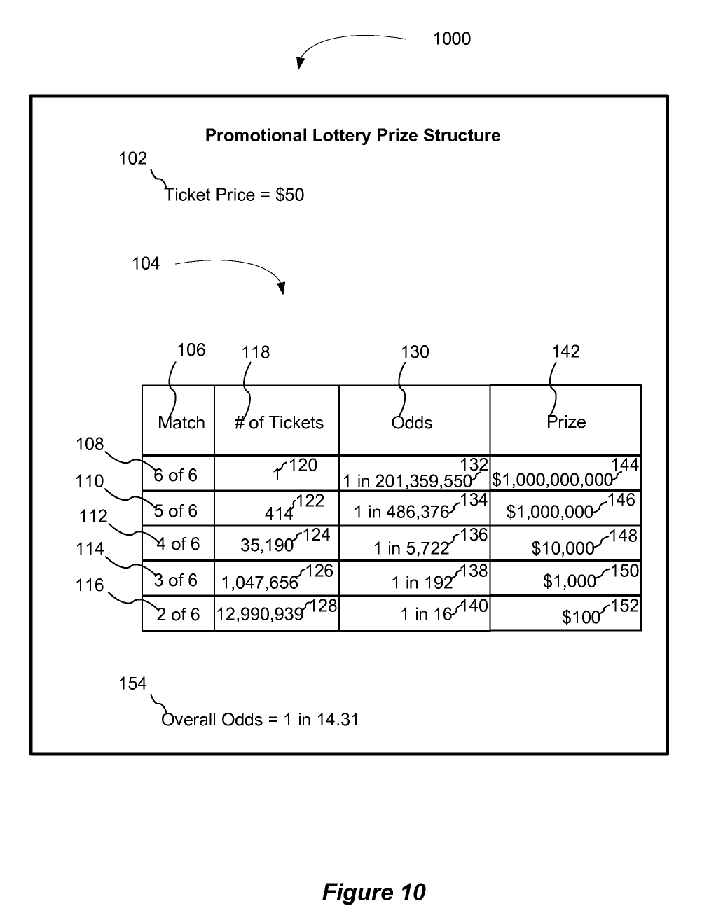

FIG. 10 illustrates a promotional lottery prize structure 1000. The promotional lottery prize structure 1000 has the same prize structure as the probabilities-based raffle prize structure 100, but is utilized with a promotional lottery game rather than a probabilities-based raffle game.

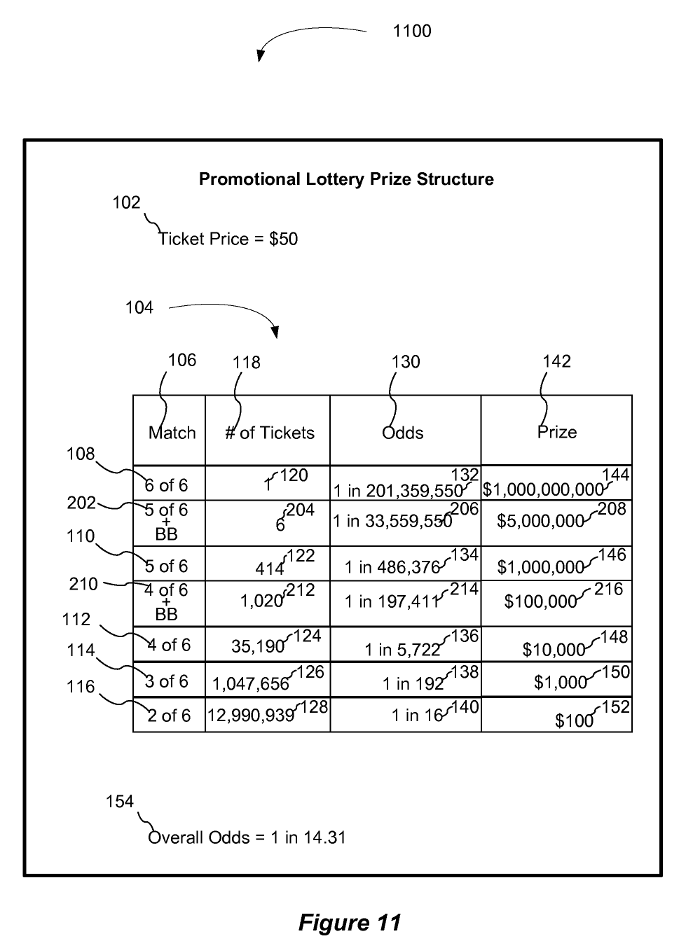

FIG. 11 illustrates a promotional lottery prize structure 1100 that is an alternative configuration of the promotional lottery prize structure 1000 illustrated in FIG. 10. The promotional lottery prize structure 1100 has the same prize structure as the probabilities-based raffle prize structure 200 illustrated in FIG. 2, but is utilized with a promotional lottery game rather than a probabilities-based raffle game.

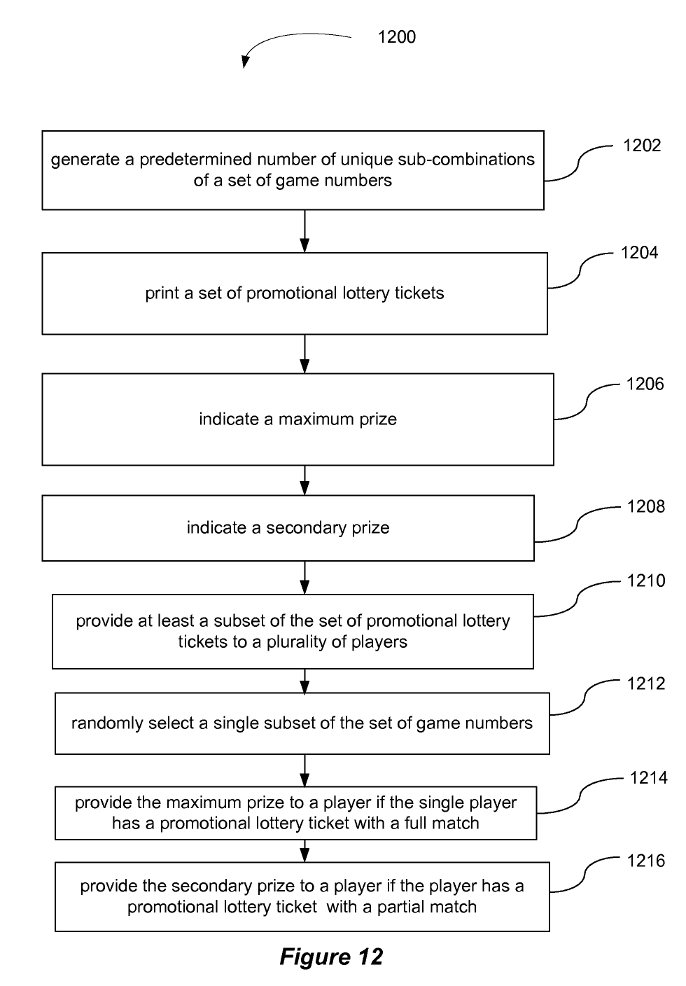

FIG. 12 illustrates process that may be utilized to provide a promotional lottery game. At a process block 1202, the process 1200 generates a predetermined number of unique sub-combinations of a set of game numbers. Each of the sub-combinations has the same quantity of numbers. Further, at a process block 1204, the process 1200 prints a set of promotional lottery tickets for a promotional lottery game such that each of the promotional lottery tickets in the set of promotional lottery tickets distinctly corresponds to one of the unique sub-combinations of the set of game numbers. In addition, at a process block 1206, the process 1200 indicates a maximum prize that is won by a player having a promotional lottery ticket with a full match. At a process block 1208, the process 1200 also indicates a secondary prize that is won by a player having a promotional lottery ticket with a partial match. Further, at a process block 1210, the process 1200 provides at least a subset of the set of promotional lottery tickets to a plurality of players in the promotional lottery game. In addition, at a process block 1212, the process 1200 randomly selects a single subset of the set of game numbers that has the same quantity of numbers as each of the sub-combinations. At a process block 1214, the process 1200 also provides the maximum prize to a player if the player has a promotional lottery ticket with a full match between the unique sub-combination corresponding to the promotional lottery ticket and the single subset of the set of game numbers that is selected. Finally, at a process block 1216, the process 1200 provides the secondary prize to a player if the player has a promotional lottery ticket with a partial match between the unique sub-combination corresponding to the promotional lottery ticket and the single subset of the set of game numbers that is selected.

Further, any of the configurations for the promotional lottery described herein may be utilized with a frequency priced promotional lottery. In other words, a player may purchase a larger quantity of tickets for a higher price. Accordingly, the frequency priced display 500 may also be utilized to provide a display of price and quantity of frequency priced promotional lottery tickets similar to the display of price and quantity of frequency priced probabilities-based raffle tickets. A ratio of the second price category to the second predetermined quantity of one or more promotional lottery tickets is less than a ratio of the first price category to the first predetermined quantity of one or more promotional lottery tickets. For example, a player is incentivized to purchase a group of three promotional lottery tickets for one hundred dollars rather than purchase three individual promotional lottery tickets separately for a total of one hundred fifty dollars.

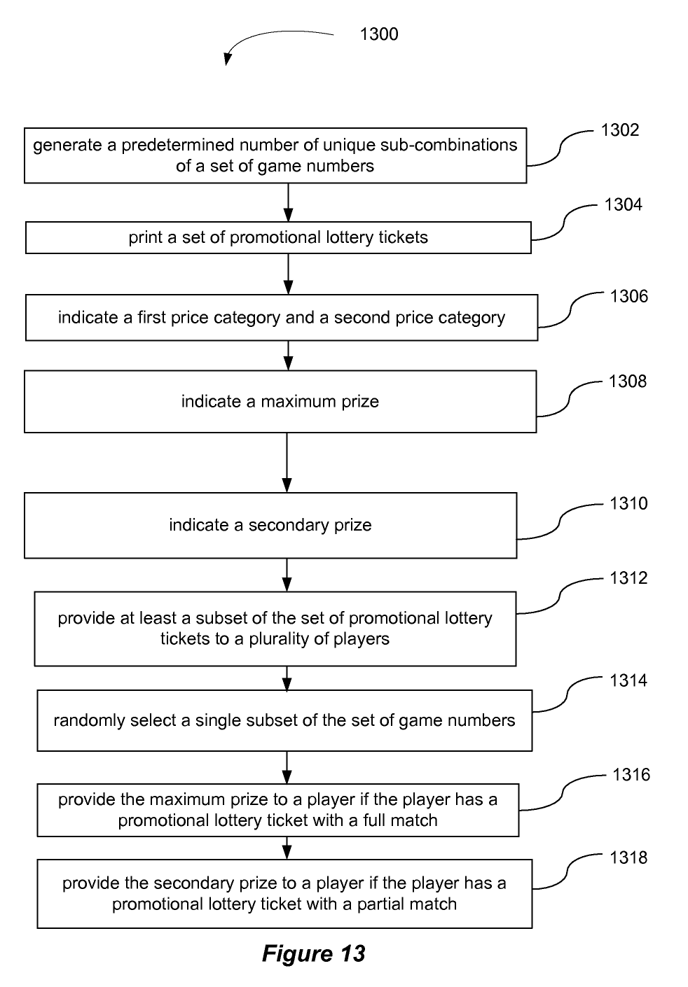

FIG. 13 illustrates a process 1300 that may be utilized in a frequency priced promotional lottery game. At a process block 1302, the process 1300 generates a predetermined number of unique sub-combinations of a set of game numbers. Each of the sub-combinations has the same quantity of numbers. Further, at a process block 1304, the process 1300 prints a set of promotional lottery tickets for a promotional lottery game such that each of the promotional lottery tickets in the set of promotional lottery tickets distinctly corresponds to one of the unique sub-combinations of the set of game numbers. In addition, at a process block 1306, the process 1300 indicates a first price category and a second price category from which one or more promotional lottery tickets can be purchased such that (i) the first price category corresponds to a first predetermined known quantity of one or more promotional lottery tickets and the second price category corresponds to a second predetermined known quantity of one or more promotional lottery tickets and (ii) a ratio of the second price category to the second predetermined quantity of one or more promotional lottery tickets is less than a ratio of the first price category to the first predetermined quantity of one or more promotional lottery tickets. At a process block 1308, the process 1300 also indicates a maximum prize that is won by a player having a promotional lottery ticket with a full match. Further, at a process block 1310, the process 1300 indicates a secondary prize that is won by a player having a promotional lottery ticket with a partial match. In addition, at a process block 1312, the process 1300 provides at least a subset of the set of promotional lottery tickets to a plurality of players in the promotional lottery game. At a process block 1314, the process 1300 also randomly selects a single subset of the set of game numbers that has the same quantity of numbers as each of the sub-combinations. Further, at a process block 1316, the process 1300 provides the maximum prize to a player if the player has a promotional lottery ticket with a full match between the unique sub-combination corresponding to the promotional lottery ticket and the single subset of the set of game numbers that is selected. In addition, at a process block 1318, the process 1300 provides the secondary prize to a player if the player has a promotional lottery ticket with a partial match between the unique sub-combination corresponding to the promotional lottery ticket and the single subset of the set of game numbers that is selected.

In an alternative embodiment, the configurations provided herein for the probabilities-based raffle game or promotional lottery game may utilized with variable pricing. In other words, the price of a lottery ticket has an initial value and may change based on the size of the maximum prize, which may increase in size based on ticket sales. Irrespective of which variable price the ticket was purchased, the player may win the final prize value. In other words, a player that buys a ticket before the variable price changes has the same opportunity to win the same maximum prize as a player that buys a ticket after the variable price increases. Accordingly, a player is incentivized to purchase a ticket as early as possible.

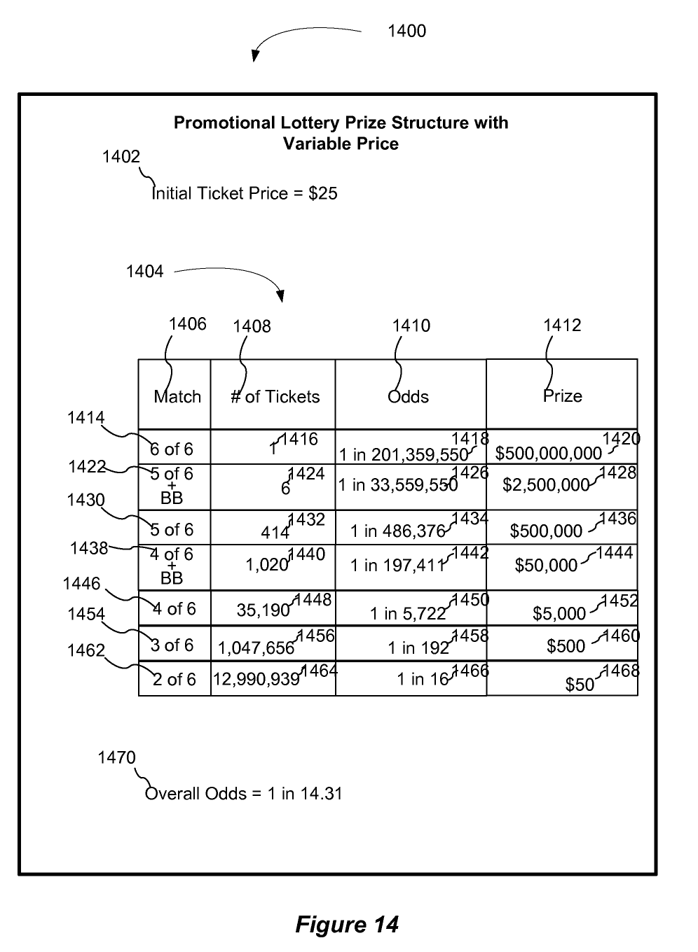

FIG. 14 illustrates a promotional lottery prize structure 1400 with a variable price. As an example, the initial ticket price 1402 is twenty five dollars. Further, the maximum prize has an initial annuity value of five hundred million dollars. If lottery ticket sales surpass a predetermined ticket sales threshold, the maximum prize may be increased. As an example, the predetermined ticket sales threshold may be four hundred million dollars of ticket sales. In one embodiment, the predetermined ticket sales threshold may be determined by the lottery as an amount needed to fund the illustrated prize values. In another embodiment, the predetermined ticket sales threshold may be determined by the lottery as an amount that meets profit margin criteria. Once the predetermined ticket sales threshold is surpassed, the maximum prize may grow. In one embodiment, the maximum prize increases by a percentage of ticket sales. For example, a portion of every ticket sold after the predetermined ticket sales threshold is surpassed is allocated to an increase in the maximum prize. Further, once the maximum prize increases such that the maximum prize value surpasses a predetermined maximum prize value, the variable price increases. For example, once the maximum prize increases to six hundred million dollars, the variable ticket price may increase to thirty dollars.

The promotional lottery prize structure 1400 may utilize a BB in addition to regular balls. In other words, six numbers are drawn, and then an additional BB is drawn. In one embodiment, that BB is simply one of the remaining balls, e.g., one of the remaining sixty nine balls out of seventy five balls in a hopper. In another embodiment, the BB is a ball drawn from a separate hopper. In yet another embodiment, the BB has a different indicia other than a number such as a color or a shape.

The promotional lottery prize structure 1400 has a display 1404 that has a match field 1406, a number of tickets field 1408, an odds filed 1410, and a prize field 1412. As an example, the match field 1406 indicates that a six of six match 1414 exists for one ticket 1416 to win a maximum prize initial annuity value 1420 of five hundred million dollars wits odds of one in two hundred one million three hundred fifty nine thousand five hundred fifty. Further, the promotional lottery prize structure 1400 has additional prizes for BB possibilities. For example, a five of six plus BB match 1422 exists for six tickets 1424 two win a secondary prize of two million five hundred thousand dollars 1428 with odds of one in thirty three million five hundred fifty nine thousand five hundred fifty 1426. A five of six match 1430 exists for four hundred fourteen tickets 1432 two win a secondary prize of five hundred thousand dollars 1436. Further, a four of six plus BB match 1438 exists for one thousand twenty tickets 1440 for a fifty thousand dollar prize 1444 with odds of one in one hundred ninety seven thousand four hundred eleven 1442. In addition, a four of six match 1446 exists for thirty five thousand one hundred ninety ticket 1448 for a secondary prize of five thousand dollars 1452 with odds of one in five thousand seven hundred twenty two 1450. A three of six match 1454 exists for one million forty seven thousand six hundred fifty six tickets 1456 for a secondary prize 1460 of five hundred dollars with odds of one in one hundred ninety two 1458. Further, a two of six match 1462 exists for twelve million nine hundred ninety thousand nine hundred thirty nine tickets 1464 for a secondary prize of fifty dollars 1468 with odds of one in sixteen 1466. The overall odds of winning a prize are one in fourteen and thirty one one hundredths.

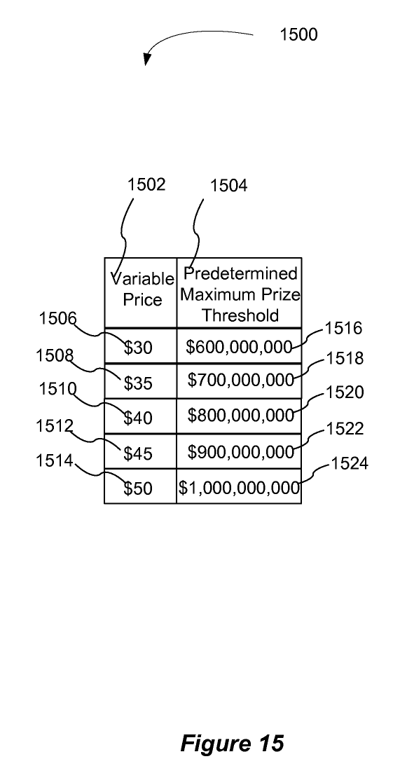

FIG. 15 illustrates an example of a display 1500 of price levels for the variable price corresponding to predetermined maximum prize thresholds. The display 1500 illustrates a variable price field 1502 and a predetermined maximum prize threshold field 1504. The variable price field indicates different price level increases based on particular predetermined maximum prize thresholds. In the example illustrated in FIG. 15, the initial variable price is twenty five dollars and the maximum prize has an initial maximum prize value of five hundred million dollars. If the maximum prize surpasses a predetermined maximum prize threshold, the variable price is increased. For example, if the maximum prize increases in value over a predetermined maximum prize threshold 1516 of six hundred million dollars, the variable price increases to a variable price 1506 of thirty dollars. Further, if the maximum prize increase in value over a predetermined maximum prize threshold 1518 of seven hundred million dollars, the variable price increases to a variable price 1508 of thirty five dollars. In addition, if the maximum prize increases in value over a predetermined maximum prize threshold 1520 of eight hundred million dollars, the variable price increases to a variable price 1510 of forty dollars. If the maximum prize increases in value over a predetermined maximum prize threshold 1522 of nine hundred million dollars, the variable price increases to a variable price 1512 of forty five dollars. Finally, if the maximum prize increases in value over a predetermined maximum prize threshold 1524 of one billion dollars, the variable price increases to a variable price 1514 of fifty dollars. If the prize grows to be one billion dollars, a player wins irrespective of whether he or she bought the ticket at the variable price of twenty five dollars, thirty dollars, thirty five dollars, forty dollars, forty five dollars, or fifty dollars. Accordingly, the player is incentivized to purchase the lottery ticket earlier to obtain a chance at a winning a prize that can grow to be significantly large at a lower price than those players that wait until that prize actually increases to the final maximum prize value. In one embodiment, a lottery may place a cap on the maximum prize. For example, the lottery may place a one billion dollar cap on the size of the maximum prize. In an alternative embodiment, the threshold can be reached rather than surpassed for the variable price change to be triggered. For example, an increase of the maximum prize in value to a predetermined maximum prize threshold 1516 of six hundred million dollars may result in the variable price increasing to a variable price 1506 of thirty dollars.

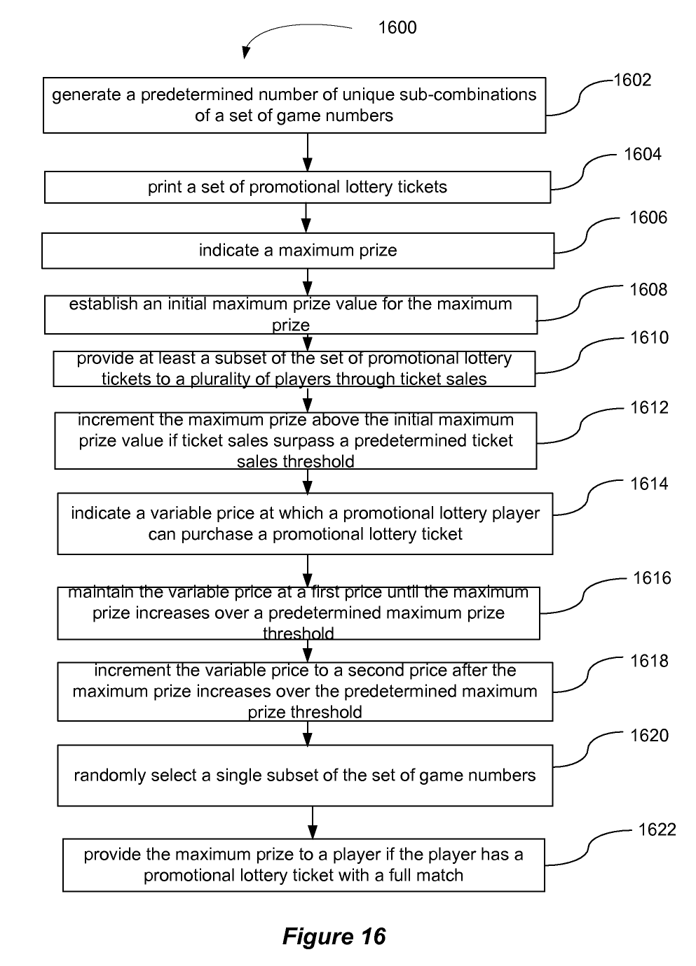

FIG. 16 illustrates a process 1600 that may be utilized to provide a variable pricing with promotional lottery tickets. At a process block 1602, the process 1600 generates a predetermined number of unique sub-combinations of a set of game numbers, each of the sub-combinations having the same quantity of numbers. Further, at a process block 1604, the process 1600 prints a set of promotional lottery tickets for a promotional lottery game such that each of the promotional lottery tickets in the set of promotional lottery tickets distinctly corresponds to one of the unique sub-combinations of the set of game numbers. In addition, at a process block 1606, the process 1600 indicates a maximum prize that a player having a promotional lottery ticket with a full match wins. At a process block 1608, the process 1600 also establishes an initial maximum prize value for the maximum prize. Further, at a process block 1610, the process 1600 provides at least a subset of the set of promotional lottery tickets to a plurality of players in the promotional lottery game through ticket sales. In addition, at a process block 1612, the process 1600 increments the maximum prize above the initial maximum prize value if ticket sales surpass a predetermined ticket sales threshold. At a process block 1614, the process 1600 also indicates a variable price at which a promotional lottery player can purchase a promotional lottery ticket. Further, at a process block 1616, the process 1600 maintains the variable price at a first price until the maximum prize increases over a predetermined maximum prize threshold. The predetermined maximum prize threshold is greater than the initial maximum prize value. In addition, at a process block 1618, the process 1600 increments the variable price to a second price after the maximum prize increases over the predetermined maximum prize threshold. At a process block 1620, the process 1600 also randomly selects a single subset of the set of game numbers that has the same quantity of numbers as each of the sub-combinations. Finally, at a process block 1622, the process 1600 provides the maximum prize to a player, irrespective of whether the player purchased the promotional lottery ticket at the variable price being the first price or at the variable price being the second price, if the player has a promotional lottery ticket with a full match between the unique sub-combination corresponding to the promotional lottery ticket and the single subset of the set of game numbers that is selected.

In yet another embodiment, the variable pricing configuration may be utilized with frequency multiple pricing. For example, prior to a maximum prize increasing in size to the predetermined maximum prize threshold of six hundred million dollars, a player may purchase a single ticket for twenty five dollars or five tickets for one hundred dollars. Accordingly, the player is incentivized to purchase five tickets for one hundred dollars rather than five individual tickets for a total of one hundred twenty five dollars. After the maximum prize increases in size to the predetermined maximum prize threshold of six hundred million dollars, the variable price may increase to thirty dollars for a single ticket and five tickets for one hundred twenty five dollars. Accordingly, the player may still purchase a ticket for the previous price of twenty five dollars, but has to purchase five tickets. Alternatively, the player may still purchase a ticket for a price that is slightly higher than the pervious price, e.g., thirty dollars, but has to purchase five tickets. Therefore, the player is incentivized to purchase tickets early in the lottery game.

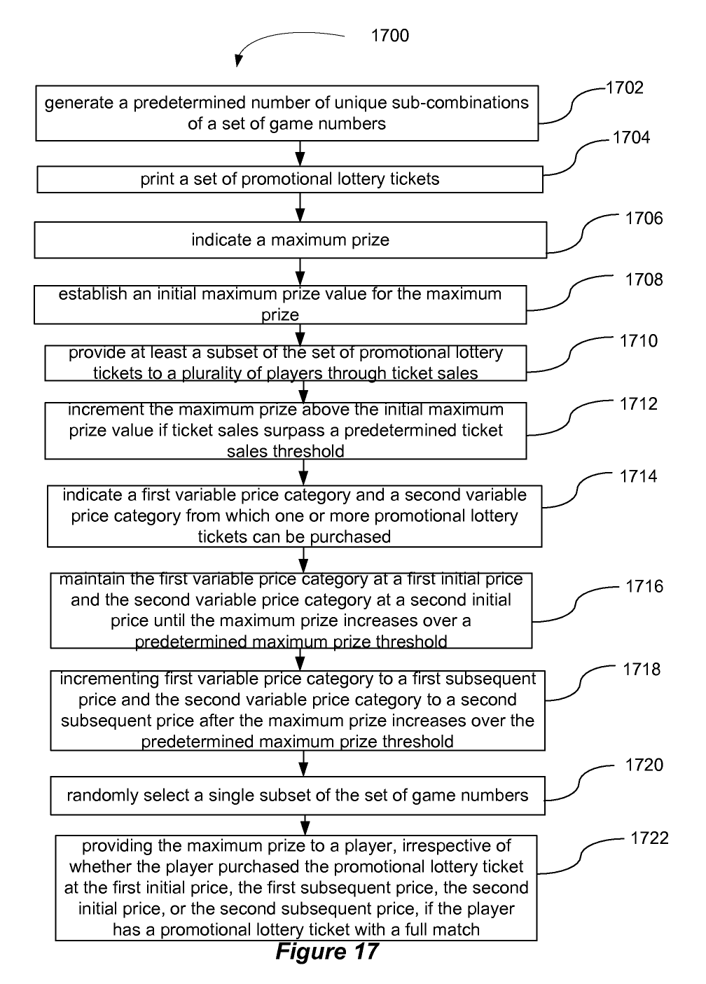

FIG. 17 illustrates a process 1700 that utilizes variable pricing with frequency multiple pricing. Further, at a process block 1702, the process 1700 generates a predetermined number of unique sub-combinations of a set of game numbers. Each of the sub-combinations has the same quantity of numbers. Further, at a process block 1704, the process 1700 prints a set of promotional lottery tickets for a promotional lottery game such that each of the promotional lottery tickets in the set of promotional lottery tickets distinctly corresponds to one of the unique sub-combinations of the set of game numbers. In addition, at a process block 1706, the process 1700 indicates a maximum prize that a player having a promotional lottery ticket with a full match wins. At a process block 1708, the process 1700 also establishes an initial maximum prize value for the maximum prize. Further, at a process block 1708, the process 1710 provides at least a subset of the set of promotional lottery tickets to a plurality of players in the promotional lottery game through ticket sales. In addition, at a process block 1712, the process 1700 increments the maximum prize above the initial maximum prize value if ticket sales surpass a predetermined ticket sales threshold. At a process block 1714, the process 1700 also indicates a first variable price category and a second variable price category from which one or more promotional lottery tickets can be purchased such that (i) the first variable price category corresponds to a first predetermined known quantity of one or more promotional lottery tickets and the second variable price category corresponds to a second predetermined known quantity of one or more promotional lottery tickets and (ii) a ratio of the second variable price category to the second predetermined quantity of one or more promotional lottery tickets is less than a ratio of the first price variable category to the first predetermined quantity of one or more promotional lottery tickets. Further, at a process block 1716, the process 1700 maintains the first variable price category at a first initial price and the second variable price category at a second initial price until the maximum prize increases over a predetermined maximum prize threshold, the predetermined maximum prize threshold being greater than the initial maximum prize value. In addition, at a process block 1716, the process 1700 increments the first variable price category to a first subsequent price and the second variable price category to a second subsequent price after the maximum prize increases over the predetermined maximum prize threshold. At a process block 1718, the process 1700 also randomly selects a single subset of the set of game numbers that has the same quantity of numbers as each of the sub-combinations. Finally, at a process block 1720, the process 1700 provides the maximum prize to a player, irrespective of whether the player purchased the promotional lottery ticket at the first initial price, the first subsequent price, the second initial price, or the second subsequent price, if the player has a promotional lottery ticket with a full match between the unique sub-combination corresponding to the promotional lottery ticket and the single subset of the set of game numbers that is selected.

The variable pricing configurations described herein may be implemented with a maximum prize that that does not have an initial value. For example, the maximum prize may be a progressive prize that starts with a value of zero and builds in value based on portions of tickets sold.

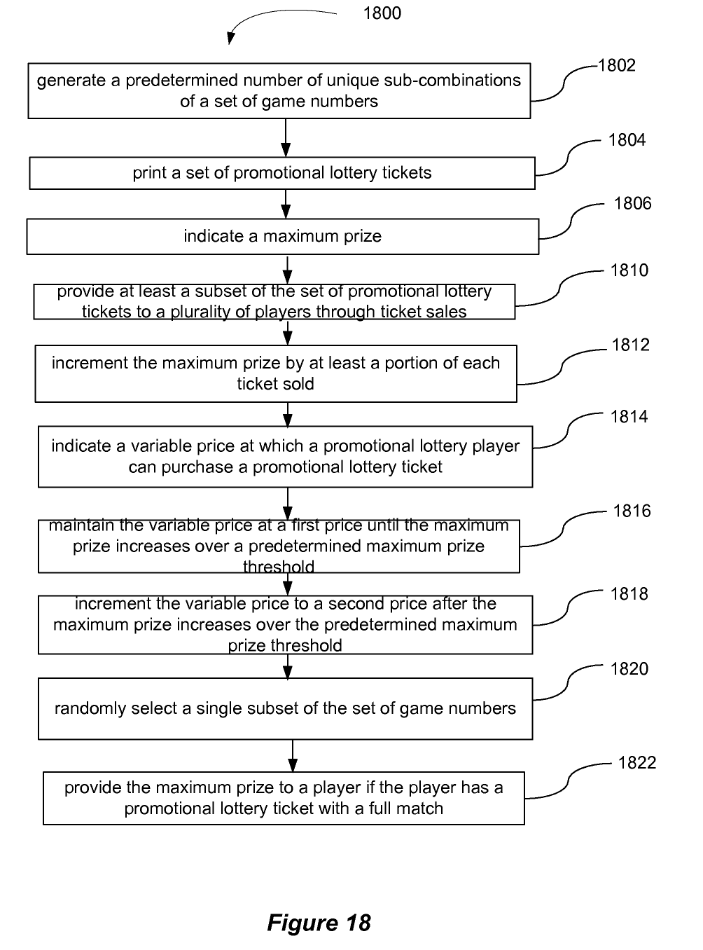

FIG. 18 illustrates a process 1800 that may be utilized with variable pricing. At a process block 1802, the process 1800 generates a predetermined number of unique sub-combinations of a set of game numbers, each of the sub-combinations having the same quantity of numbers. Further, at a process block 1804, the process 1800 prints a set of promotional lottery tickets for a promotional lottery game such that each of the promotional lottery tickets in the set of promotional lottery tickets distinctly corresponds to one of the unique sub-combinations of the set of game numbers. In addition, at a process block 1806, the process 1800 indicates a maximum prize that a player having a promotional lottery ticket with a full match wins. At a process block 1808, the process 1800 also provides at least a subset of the set of promotional lottery tickets to a plurality of players in the promotional lottery game through ticket sales. Further, at a process block 1810, the process 1800 increments the maximum prize by at least a portion of each ticket sold. In addition, at a process block 1812, the process 1800 indicates a variable price at which a promotional lottery player can purchase a promotional lottery ticket. At a process block 1814, the process 1800 also maintains the variable price at a first price until the maximum prize increases over a predetermined maximum prize threshold. Further, at a process block 1816, the process 1800 increments the variable price to a second price after the maximum prize increases over the predetermined maximum prize threshold. In addition, at a process block 1818, the process 1800 randomly selects a single subset of the set of game numbers that has the same quantity of numbers as each of the sub-combinations. Finally, at a process block 1820, the process 1800 provides the maximum prize to a player, irrespective of whether the player purchased the promotional lottery ticket at the variable price being the first price or at the variable price being the second price, if the player has a promotional lottery ticket with a full match between the unique sub-combination corresponding to the promotional lottery ticket and the single subset of the set of game numbers that is selected.

The configurations described herein are not limited to a single lottery matrix. For example, the numbers drawn may be from a multi-lottery matrix such as a dual matrix. As an example, the dual matrix may be five of fifty six number and one of forty six numbers. Further, one or more ball hoppers may be utilize for a lottery drawing.

Further, the subsequent random selection may also be utilized for the promotional lottery, variable pricing, and/or variable pricing with frequency pricing configurations described herein. For example, if thirty percent of the promotional lottery tickets with variable pricing are sold, the ticket with the full match may potentially be in the seventy percent of the tickets that were not sold. In one embodiment, a subsequent random selection such as a subsequent drawing may be performed from the sets of numbers on the promotional lottery tickets that were sold to ensure a full match winner for the maximum prize.

In addition, the increase of secondary prizes discussed with respect to the process 300 may be utilized for the promotional lottery, variable pricing, and/or variable pricing with frequency pricing configurations described herein. Accordingly, a secondary prize may be increased by an additional amount if the total percentage of actual ticket sales subtracted from the predetermined percentage of ticket sales results in a remainder. The additional amount is less than or equal to the remainder. In one embodiment, the actual ticket sales are the ticket sales that fall within a cap. For example, a cap may be one billion dollars. Accordingly, at most a total percentage of one billion dollars may be utilized for purposes of being subtracted from the predetermined percentage of ticket sales. The cap may be utilized with the probabilities-based raffle game or the promotional lottery game to calculate a secondary prize increase.

The types of secondary prizes described herein may also be utilized for the promotional lottery, variable pricing, and/or variable pricing with frequency pricing configurations described herein. For example, a pari-mutuel secondary prize may be utilized. Further, an estimate of the secondary prize may be displayed.

Any of the configurations described herein may be utilized with a single primary prize or a plurality of primary prizes. The term primary prize is intended to be a prize that is larger in value than a secondary prize. The primary prize may or may not be a maximum prize. A hybrid prize structure may be utilized. For example, one type of random selection may be utilized for a first prize category and another type of random selection may be utilized for a second prize category that is distinct from the first prize category.

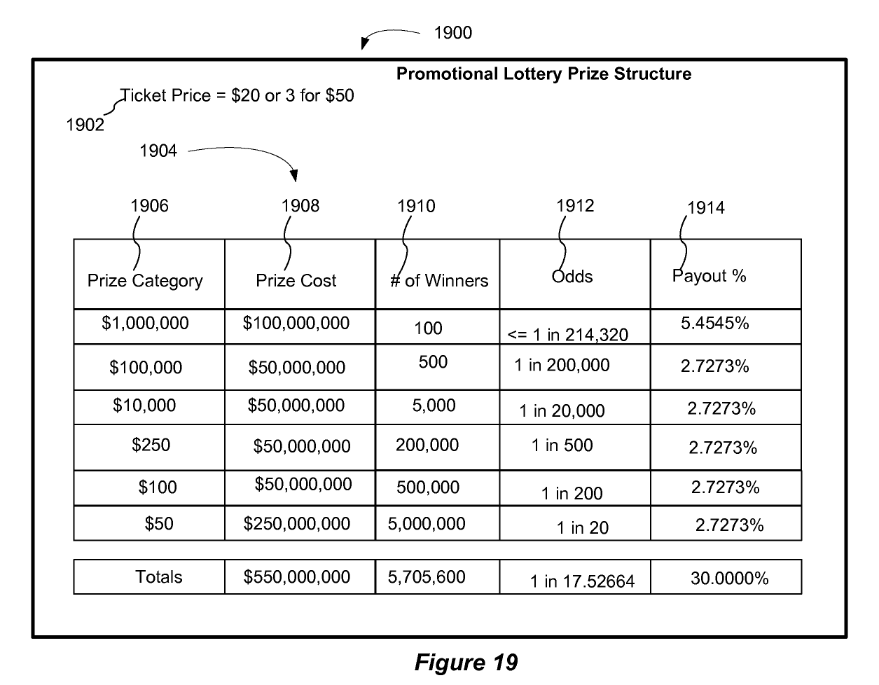

FIG. 19 illustrates a promotional lottery prize structure 1900 with a predetermined minimum number of primary prizes and a plurality of secondary prizes. As an example, the ticket price 1902 may be twenty dollars for a single ticket or three tickets for fifty dollars. However, any of the pricing structures described herein by be utilized. Further, the promotional lottery prize structure 1900 has a display 1904. The display 1904 illustrates a prize category 1906 filed, a prize cost field 1908, a number of winners field 1910, an odds field 1912, and a payout percentage field 1914. The price category field 1906 has various prize levels with a corresponding number of winners. The prize category has primary prizes and secondary prizes. The primary prizes are one million dollars prizes and the secondary prizes are all other prizes with a lesser value such as one hundred thousand dollars, ten thousand dollars, two hundred fifty dollars, one hundred dollars, and fifty dollars. In one embodiment, the minimum number of primary prizes is won in each promotional lottery game. For example, at a minimum, one hundred tickets are winning tickets of the one million dollar prize. To ensure such a minimum, one hundred different sets of digits are drawn from the sets of digits actually sold on tickets. Accordingly, no one million dollar prizes are selected from tickets that have not been sold. However, the secondary prizes may not necessarily all be provided to each of the indicated number of winners. For example, the only two hundred winners of the one hundred thousand dollar prize may be selected from the sold tickets and the other three hundred numbers may have been selected from the unsold tickets. In one embodiment, the winning tickets of a secondary prize level share the payout percentage of that particular secondary prize. For example, two hundred winners of the one hundred thousand dollar prize may share slightly under three percent of the total sales. That share may be less than, equal to, or greater than one hundred thousand dollars. As described herein, the secondary prizes may be pari-mutuel, estimates, etc. In another embodiment, the number of winning tickets is not displayed and the prize level is constant with a chance of increasing if a remainder as described herein exists. Accordingly, the number of winning tickets is determined based on the payout percentage of the actual tickets sales such that, at a minimum, the constant secondary prize, e.g., one hundred thousand dollars or an annuity thereof, is provided.

In one embodiment, the predetermined minimum number of primary prizes may increase. For example, a predetermined percentage of tickets sales to be paid in prizes won for the promotional lottery game may be established. The quantity of primary prizes may be increased over the predetermined minimum number of primary prizes based on a remainder being greater than or equal to a primary prize in the predetermined minimum number of primary prizes. The remainder resulting from the total percentage of actual ticket sales subtracted from the predetermined percentage of ticket sales. In one embodiment, the predetermined percentage of ticket sales is a percentage that generates enough revenue to equal costs of prizes in the promotional lottery. For example, the number of primary prizes may be increased to one hundred fifty one million dollar prizes. In one embodiment, a guarantee may be provided for some or all of the amount of sales that achieve a break event status of revenues equaling costs.

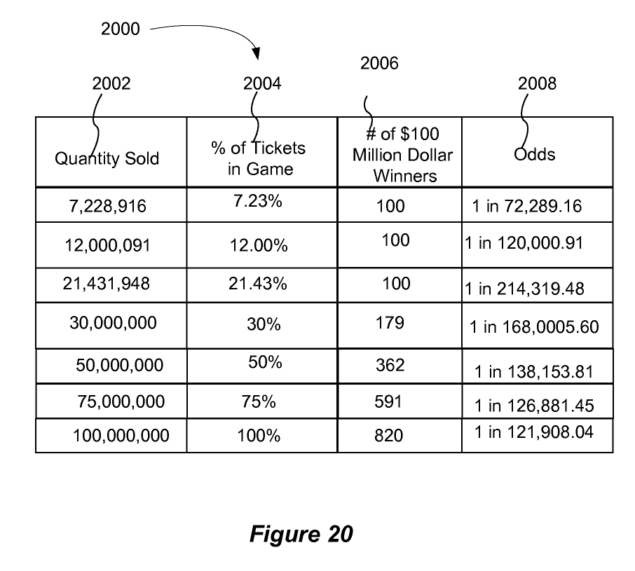

FIG. 20 illustrates a display 2000 of the odds as the number of primary prizes stays constant and then changes. At first, the odds of winning a primary prize are relatively good and then decrease towards the break even point. After the break even points is surpassed, the odds increase again as the number of primary prizes is increased. As an example, for each two million dollar increase in sales above the break even point, one additional primary prize may be provided. Accordingly, no additional risk is added by providing that additional primary prize. Therefore, a guarantee is provided for a portion or all of sales up until the break even point and then is no longer needed.

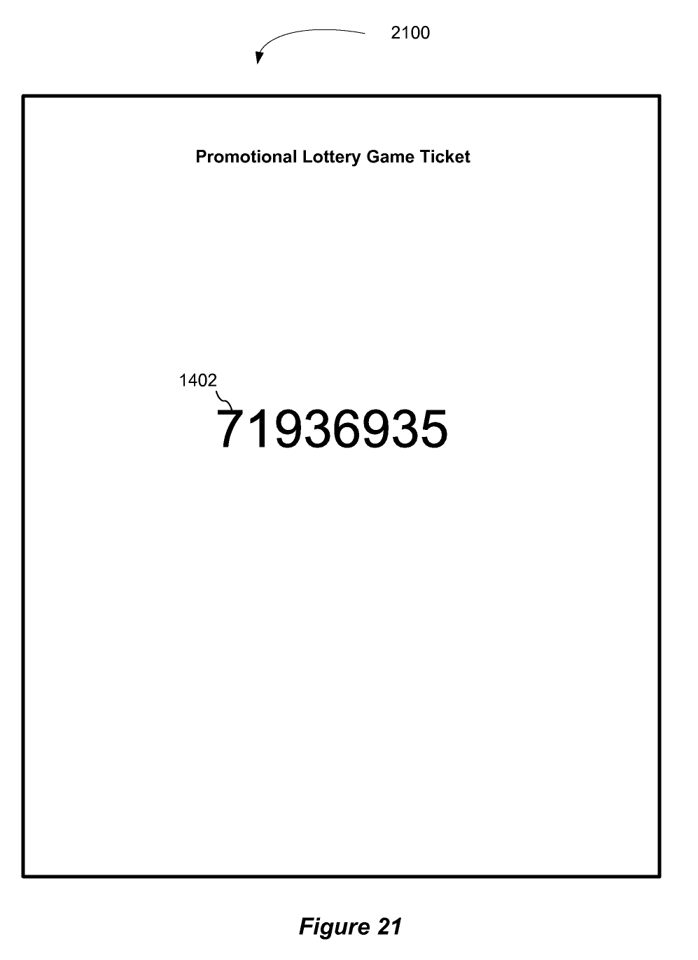

FIG. 21 illustrates an example of a promotional lottery ticket 2100. The promotional lottery ticket 2100 may have a unique set of digits 1402. In one embodiment, a drawing of a set of digits is performed for each prize. Accordingly, the first one hundred sets of digits drawn are for the one million dollar prize, the next five hundred numbers drawn are for the one hundred thousand dollar prize, etc. In another embodiment, iterations are performed for the primary prize. For example, the first one hundred sets of digits drawn are for the one million dollar prize. Instead of drawing numerous sets of digits for a large number of secondary prizes, an additional set of digits may be drawn for the secondary prizes. Certain criteria based on that single set of digits may be determined. For example a match of the first six or last six numbers of the ordered set of digits may result in one of the secondary prizes. In another embodiment, some additional iterations may be performed for some of the secondary prizes and a single additional set of digits may be selected and utilized for other secondary prizes.

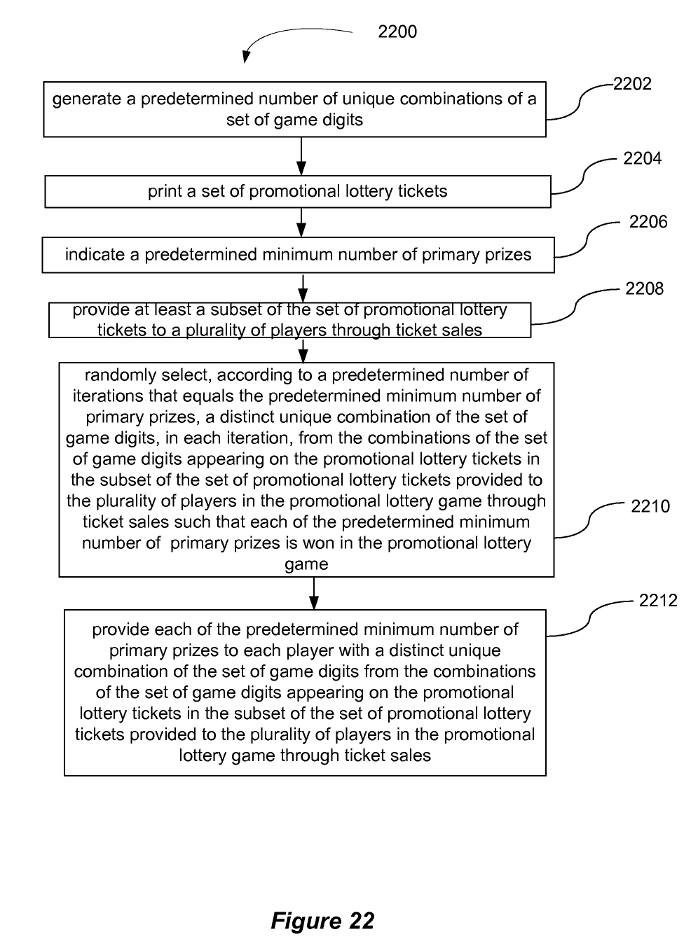

FIG. 22 illustrates a process 2200 that may be utilized to implement multiple primary prizes. At a process block 2202, the process 200 generates a predetermined number of unique combinations of a set of game digits. Each of the combinations has the same quantity of digits. Further, a process block 2204, the process 2200 prints a set of promotional lottery tickets for a promotional lottery game such that each of the promotional lottery tickets in the set of promotional lottery tickets distinctly corresponds to one of the unique combinations of the set of game digits. In addition, at a process block 2206, the process 2200 indicates a predetermined minimum number of primary prizes. At a process block 2208, the process 2200 also provides at least a subset of the set of promotional lottery tickets to a plurality of players in the promotional lottery game through ticket sales. Further, at a process block 2210, the process 2200 randomly selects, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game. In addition, at a process block 2212, the process 2200 provides each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales. In another embodiment, the process 2200 may be utilized to implement a single primary prize. In yet another embodiment, the process 2200 may be utilized to implement a predetermined minimum number of prizes having a single primary prize, and the number of primary prizes may surpass that predetermined minimum number.

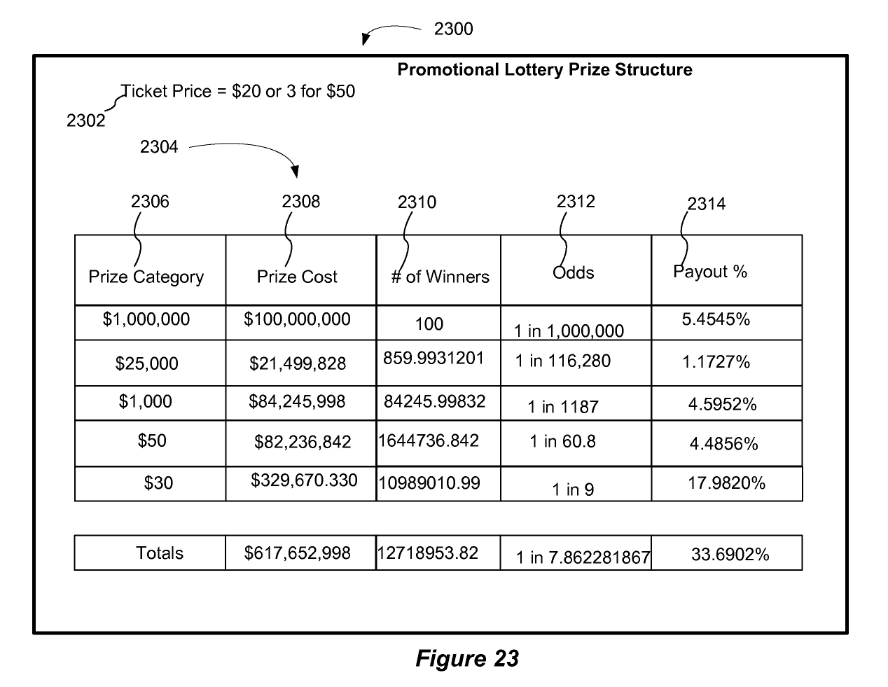

FIG. 23 illustrates a promotional lottery prize structure 2300. The predetermined number of minimum primary prizes is similar to that of the promotional lottery prize structure 1900 illustrated in FIG. 19. For example, one hundred iterations of are performed to select one hundred sets of digits from the sets of digits printed on promotional lottery tickets actually sold. However, the secondary prize winning tickets are selected according to a lottery matrix. For example, a separate set of numbers, which is selected from a larger set of numbers, may be printed on a lottery ticket. For example, seven numbers may be selected from twenty one numbers. Accordingly, different secondary prizes may be provided based on the type of match with the secondary prize. For example, a seven of twenty one match may result in a twenty five thousand dollar prize, a six of twenty one match may result in a one thousand dollar prize, a five of twenty one match may result in a fifty dollar prize, and a four of twenty one match may result in a thirty dollar prize. The types of secondary prizes and possible increases in primary prizes are configured similarly to the promotional lottery prize structure 1900 illustrated in FIG. 19. The primary prize data illustrated in FIG. 23 is dependent upon all tickets being sold and the number of primary prizes not increasing. If these conditions are changed, the primary prize data may be different.

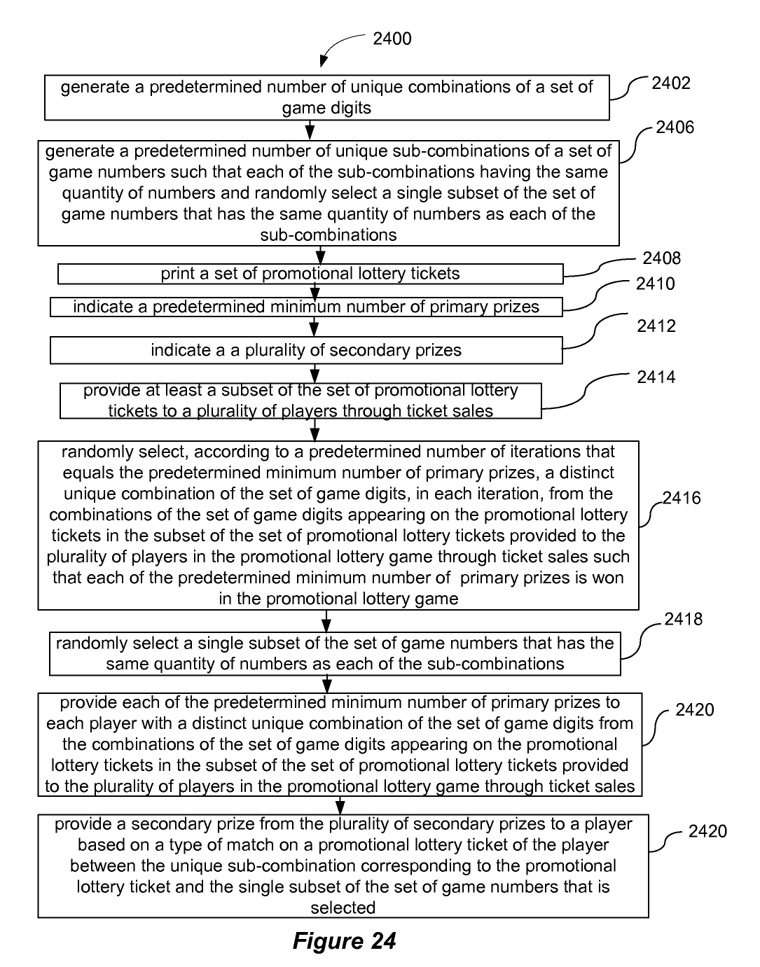

FIG. 24 illustrates another process 2400 that utilized to implement multiple primary prizes. At a process block 2402, the process 2400 generates a predetermined number of unique combinations of a set of game digits. Each of the combinations has the same quantity of digits. Further, at a process block 2406, the process 2400 generates a predetermined number of unique sub-combinations of a set of game numbers such that each of the sub-combinations having the same quantity of numbers and randomly selecting a single subset of the set of game numbers that has the same quantity of numbers as each of the sub-combinations. In addition, at a process block 2408, the process 2400 prints a set of promotional lottery tickets for a promotional lottery game such that each of the promotional lottery tickets in the set of promotional lottery tickets corresponds to one of the unique sub-combinations of a set of game numbers and distinctly corresponds to one of the unique combinations of the set of game digits. At a process block 2410, the process 2400 also indicates a predetermined minimum number of primary prizes. Further, at a process block 2412, the process 2400 indicates a plurality of secondary prizes. Each of the secondary prizes in the plurality of secondary prizes has a lesser value than each of the predetermined minimum number of primary prizes. In addition, at a process block, the process 2400 provides at least a subset of the set of promotional lottery tickets to a plurality of players in the promotional lottery game through ticket sales. At a process block 2414, the process 2400 also randomly selects, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game. Further, at a process block 2416, the process 2400 randomly selects a single subset of the set of game numbers that has the same quantity of numbers as each of the sub-combinations. In addition, at a process block 2418, the process 2400 provides each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales. Finally, at a process block 2420, the process 2400 provides a secondary prize from the plurality of secondary prizes to a player based on a type of match on a promotional lottery ticket of the player between the unique sub-combination corresponding to the promotional lottery ticket and the single subset of the set of game numbers that is selected.

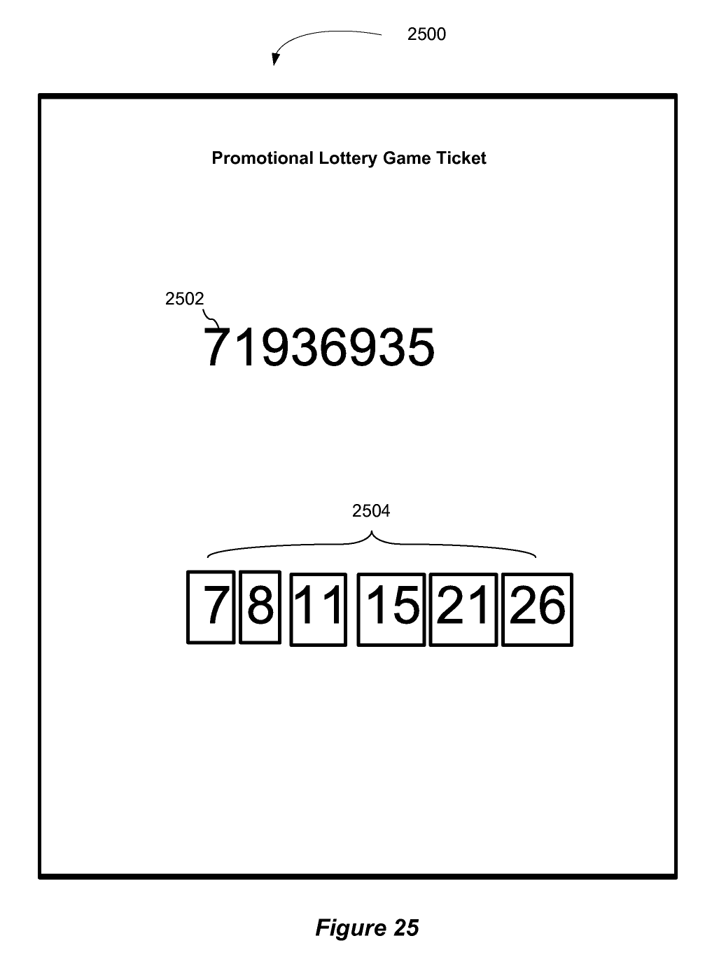

FIG. 25 illustrates an example of a promotional lottery ticket 2500. The promotional lottery ticket 2500 may have a unique set of digits 2502 and a set of numbers 2504. In one embodiment, a drawing of a set of digits is performed for each prize primary prize. Accordingly, the first one hundred sets of digits drawn are for the one million dollar prize. Further, a drawing is performed from lottery matrix, e.g., six of twenty nine.

Any of the configurations described above are not limited to the utilization of numbers. Any type of indicia or symbols may be utilized.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes and systems. Therefore, it is to be understood that, within the scope of the appended claims, the present processes and systems may be practiced other than as specifically described herein.

We claim:

1. A method comprising:
generating a predetermined number of unique combinations of a set of game digits, each of the combinations having the same quantity of digits;
printing a set of promotional lottery tickets for a promotional lottery game such that each of the promotional lottery tickets in the set of promotional lottery tickets distinctly corresponds to one of the unique combinations of the set of game digits;
indicating a predetermined minimum number of primary prizes;
providing at least a subset of the set of promotional lottery tickets to a plurality of players in the promotional lottery game through ticket sales;
randomly selecting, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game; and
providing each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales.

2. The method of claim 1, further comprising indicating a plurality of secondary prizes, each of the secondary prizes in the plurality of secondary prizes having a lesser value than each of the predetermined minimum number of primary prizes.

3. The method of claim 2, further comprising randomly selecting, according to a predetermined number of iterations that equals a constant quantity of the secondary prizes in the plurality of secondary prizes, a distinct unique combination of the set of game digits, in each iteration, from the predetermined number of unique combinations of the set of game digits.

4. The method of claim 3, wherein the plurality of secondary prizes is a set of pari-mutuel based secondary prizes that are based on a predetermined portion of ticket sales.

5. The method of claim 4, wherein the indicating the plurality of secondary prizes is providing an estimate of each of secondary prizes in the plurality of secondary prizes.

6. The method of claim 5, further comprising establishing, prior to the providing the at least the subset of the set of promotional lottery tickets to the plurality of players in the promotional lottery game, a predetermined percentage of tickets sales to be paid for the secondary prizes won from the plurality of secondary prizes for the promotional lottery game.

7. The method of claim 6, further comprising modifying each of the secondary prizes in the plurality of secondary prizes in relation to the estimate based on a number of winners of the secondary prizes in the plurality of secondary prizes and ticket sales volume.

8. The method of claim 2, further comprising randomly selecting, according to a number of iterations, which is determined based on a predetermined percentage of tickets sales to be paid for the secondary prizes won from the plurality of secondary prizes for the promotional lottery game, a distinct unique combination of the set of game digits, in each iteration, from the predetermined number of unique combinations of the set of game digits.

9. The method of claim 8, wherein the plurality of secondary prizes is a set of predetermined constant secondary prizes.

10. The method of claim 2, further comprising establishing, prior to the providing the at least the subset of the set of promotional lottery tickets to the plurality of players in the promotional lottery game, a predetermined percentage of tickets sales to be paid in prizes won for the promotional lottery game and increasing each of the secondary prizes in the plurality of secondary prizes by an additional amount if the total percentage of actual ticket sales subtracted from the predetermined percentage of ticket sales results in a remainder, the additional amount being less than or equal to the remainder.

11. The method of claim 2, further comprising establishing, prior to the providing the at least the subset of the set of promotional lottery tickets to the plurality of players in the promotional lottery game, a predetermined percentage of tickets sales to be paid in prizes won for the promotional lottery game and increasing each of the predetermined minimum number of primary prizes by an additional amount if the total percentage of actual ticket sales subtracted from the predetermined percentage of ticket sales results in a remainder, the additional amount being less than or equal to the remainder.

12. The method of claim 2, further comprising establishing, prior to the providing the at least the subset of the set of promotional lottery tickets to the plurality of players in the promotional lottery game, a predetermined percentage of tickets sales to be paid in prizes won for the promotional lottery game and increasing each of the predetermined minimum number of primary prizes by a first additional amount in addition to increasing each of the secondary prizes in the plurality of secondary prizes by a second additional amount if the total percentage of actual ticket sales subtracted from the predetermined percentage of ticket sales results in a remainder, the total of the first additional amount and the second additional amount being less than or equal to the remainder.

13. The method of claim 2, further comprising randomly selecting, an additional distinct unique combination of the set of game digits from the predetermined number of unique combinations of the set of game digits.

14. The method of claim 13, further comprising providing a secondary prize from the plurality of secondary prizes to a player if the player has a promotional lottery ticket with at least an ordered predetermined number of digits in the additional distinct unique combination of the set of game digits from the predetermined number of unique combinations of the set of game digits.

15. The method of claim 2, further comprising generating a predetermined number of unique sub-combinations of a set of game numbers such that each of the sub-combinations having the same quantity of numbers and randomly selecting a single subset of the set of game numbers that has the same quantity of numbers as each of the sub-combinations.

16. The method of claim 15, further comprising printing one of the unique sub-combinations of the set of game numbers on each promotional lottery ticket in the set of promotional lottery tickets.

17. The method of claim 15, further comprising providing a secondary prize from the plurality of secondary prizes to a player based on a type of match on a promotional lottery ticket of the player between the unique sub-combination corresponding to the promotional lottery ticket and the single subset of the set of game numbers that is selected.

18. The method of claim 2, further comprising indicating a predetermined number prize distribution that can be won with a promotional lottery ticket purchased after a first predetermined number of other promotional lottery tickets have been sold.

19. The method of claim 1, further comprising establishing, prior to the providing the at least the subset of the set of promotional lottery tickets to the plurality of players in the promotional lottery game, a predetermined percentage of tickets sales for the promotional lottery game and increasing a quantity of primary prizes over the predetermined minimum number of primary prizes based on a remainder being greater than or equal to a primary prize in the predetermined minimum number of primary prizes, the remainder resulting from the predetermined percentage of ticket sales subtracted from the total percentage of actual ticket sales.

20. The method of claim 19, wherein the predetermined percentage of ticket sales is a percentage that generates enough revenue to equal costs of prizes in the promotional lottery.

21. The method of claim 20, further comprising providing a guarantee for payment of at least a portion of at least some of the prizes in the promotional lottery.

22. The method of claim 1, further comprising establishing, prior to the providing the at least the subset of the set of promotional lottery tickets to the plurality of players in the promotional lottery game, a predetermined percentage of ticket sales and increasing a quantity of primary prizes over the predetermined minimum number of primary prizes based on a remainder being greater than or equal to two primary prizes in the predetermined minimum number of primary prizes, the remainder resulting from the predetermined percentage of ticket sales subtracted from the total percentage of actual ticket sales.

23. The method of claim 22, further comprising providing a guarantee for payment of at least a portion of at least some of the prizes in the promotional lottery prior to the remainder.

24. The method of claim 1, further comprising indicating a first price category and a second price category from which one or more promotional lottery tickets can be purchased such that (i) the first price category corresponds to a first predetermined known quantity of one or more promotional lottery tickets and the second price category corresponds to a second predetermined known quantity of one or more promotional lottery tickets and (ii) a ratio of the second price category to the second predetermined quantity of one or more promotional lottery tickets is less than a ratio of the first price category to the first predetermined quantity of one or more promotional lottery tickets.

25. A method comprising:
generating a predetermined number of unique combinations of a set of game digits, each of the combinations having the same quantity of digits;
generating a predetermined number of unique sub-combinations of a set of game numbers such that each of the sub-combinations having the same quantity of numbers and randomly selecting a single subset of the set of game numbers that has the same quantity of numbers as each of the sub-combinations;
printing a set of promotional lottery tickets for a promotional lottery game such that each of the promotional lottery tickets in the set of promotional lottery tickets corresponds to one of the unique sub-combinations of a set of game numbers and distinctly corresponds to one of the unique combinations of the set of game digits;
indicating a predetermined minimum number of primary prizes;
indicating a plurality of secondary prizes, each of the secondary prizes in the plurality of secondary prizes having a lesser value than each of the predetermined minimum number of primary prizes;
providing at least a subset of the set of promotional lottery tickets to a plurality of players in the promotional lottery game through ticket sales;
randomly selecting, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game;
randomly selecting a single subset of the set of game numbers that has the same quantity of numbers as each of the sub-combinations;
providing each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales; and
providing a secondary prize from the plurality of secondary prizes to a player based on a type of match on a promotional lottery ticket of the player between the unique sub-combination corresponding to the promotional lottery ticket and the single subset of the set of game numbers that is selected.

26. The method of claim 25, wherein each of the unique sub-combinations of a set of game numbers is selected by a player that purchases the promotional lottery ticket.

27. The method of claim 25, wherein each of the unique sub-combinations of a set of game numbers is randomly generated.

28. The method of claim 25, wherein a portion of the unique sub-combinations of a set of game numbers are selected by players that purchase promotional lottery tickets and a portion of the unique sub-combinations are randomly generated.

29. The method of claim 25, wherein the plurality of secondary prizes is a set of pari-mutuel based secondary prizes that are based on a predetermined portion of ticket sales.

30. The method of claim 29, wherein the indicating the plurality of secondary prizes is providing an estimate of each of secondary prizes in the plurality of secondary prizes.

31. The method of claim 30, further comprising establishing, prior to the providing the at least the subset of the set of promotional lottery tickets to the plurality of players in the promotional lottery game, a predetermined percentage of tickets sales to be paid for the secondary prizes won from the plurality of secondary prizes for the promotional lottery game.

32. The method of claim 31, further comprising modifying each of the secondary prizes in the plurality of secondary prizes in relation to the estimate based on a number of winners of the secondary prizes in the plurality of secondary prizes and ticket sales volume.

33. The method of claim 25, further comprising establishing, prior to the providing the at least the subset of the set of promotional lottery tickets to the plurality of players in the promotional lottery game, a predetermined percentage of tickets sales to be paid in prizes won for the promotional lottery game and increasing each of the secondary prizes in the plurality of secondary prizes by an additional amount if the total percentage of actual ticket sales subtracted from the predetermined percentage of ticket sales results in a remainder, the additional amount being less than or equal to the remainder.

34. The method of claim 25, further comprising establishing, prior to the providing the at least the subset of the set of promotional lottery tickets to the plurality of players in the promotional lottery game, a predetermined percentage of tickets sales to be paid in prizes won for the promotional lottery game and increasing each of the predetermined minimum number of primary prizes by an additional amount if the total percentage of actual ticket sales subtracted from the predetermined percentage of ticket sales results in a remainder, the additional amount being less than or equal to the remainder.

35. The method of claim 25, further comprising establishing, prior to the providing the at least the subset of the set of promotional lottery tickets to the plurality of players in the promotional lottery game, a predetermined percentage of tickets sales to be paid in prizes won for the promotional lottery game and increasing each of the predetermined minimum number of primary prizes by a first additional amount in addition to increasing each of the secondary prizes in the plurality of secondary prizes by a second additional amount if the total percentage of actual ticket sales subtracted from the predetermined percentage of ticket sales results in a remainder, the total of the first additional amount and the second additional amount being less than or equal to the remainder.

36. The method of claim 25, further comprising establishing, prior to the providing the at least the subset of the set of promotional lottery tickets to the plurality of players in the promotional lottery game, a predetermined percentage of tickets sales to be paid in prizes won for the promotional lottery game and increasing a quantity of primary prizes over the predetermined minimum number of primary prizes based on a remainder being greater than or equal to a primary prize in the predetermined minimum number of primary prizes, the remainder resulting from the predetermined percentage of ticket sales subtracted from the total percentage of actual ticket sales.

37. The method of claim 36, wherein the predetermined percentage of ticket sales is a percentage that generates enough revenue to equal costs of prizes in the promotional lottery.

38. The method of claim 37, further comprising providing a guarantee for payment of at least a portion of at least some of the prizes in the promotional lottery.

39. The method of claim 25, further comprising establishing, prior to the providing the at least the subset of the set of promotional lottery tickets to the plurality of players in the promotional lottery game, a predetermined percentage of tickets sales to be paid in prizes won for the promotional lottery game and increasing a quantity of primary prizes over the predetermined minimum number of primary prizes based on a remainder being greater than or equal to two primary prizes in the predetermined minimum number of primary prizes, the remainder resulting from the predetermined percentage of ticket sales subtracted from the total percentage of actual ticket sales.

40. The method of claim 39, further comprising providing a guarantee for payment of at least a portion of at least some of the prizes in the promotional lottery prior to the remainder.

41. The method of claim 25, further comprising indicating a first price category and a second price category from which one or more promotional lottery tickets can be purchased such that (i) the first price category corresponds to a first predetermined known quantity of one or more promotional lottery tickets and the second price category corresponds to a second predetermined known quantity of one or more promotional lottery tickets and (ii) a ratio of the second price category to the second predetermined quantity of one or more promotional lottery tickets is less than a ratio of the first price category to the first predetermined quantity of one or more promotional lottery tickets.

42. A system comprising:
a combination generation module that generates a predetermined number of unique combinations of a set of game digits, each of the combinations having the same quantity of digits;
a printer that prints a set of promotional lottery tickets for a promotional lottery game such that each of the promotional lottery tickets in the set of promotional lottery tickets distinctly corresponds to one of the unique combinations of the set of game digits;
a display module that indicates a predetermined minimum number of primary prizes;
a ticket distribution module that provides at least a subset of the set of promotional lottery tickets to a plurality of players in the promotional lottery game through ticket sales;
a random selection module that randomly selects, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game; and
a primary prize distribution module that provides each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales.

43. The system of claim 42, wherein the display module also indicates a plurality of secondary prizes, each of the secondary prizes in the plurality of secondary prizes having a lesser value than each of the predetermined minimum number of primary prizes.

44. The system of claim 43, further comprising a random selection module that randomly selects, according to a predetermined number of iterations that equals a constant quantity of the secondary prizes in the plurality of secondary prizes, a distinct unique combination of the set of game digits, in each iteration, from the predetermined number of unique combinations of the set of game digits.

45. The system of claim 44, wherein the plurality of secondary prizes is a set of pari-mutuel based secondary prizes that are based on a predetermined portion of ticket sales.

46. The system of claim 45, wherein the indicating the plurality of secondary prizes is providing an estimate of each of secondary prizes in the plurality of secondary prizes.

47. The system of claim 46, further comprising an establishment module that establishes, prior to the providing the at least the subset of the set of promotional lottery tickets to the plurality of players in the promotional lottery game, a predetermined percentage of tickets sales to be paid for the secondary prizes won from the plurality of secondary prizes for the promotional lottery game.

48. The system of claim 47, further comprising a modification module that modifies each of the secondary prizes in the plurality of secondary prizes in relation to the estimate based on a number of winners of the secondary prizes in the plurality of secondary prizes and ticket sales volume.

49. The system of claim 43, further comprising a random selection module that randomly selects, according to a number of iterations, which is determined based on a predetermined percentage of tickets sales to be paid for the secondary prizes won from the plurality of secondary prizes for the promotional lottery game, a distinct unique combination of the set of game digits, in each iteration, from the predetermined number of unique combinations of the set of game digits.

50. The system of claim 49, wherein the plurality of secondary prizes is a set of predetermined constant secondary prizes.

51. The system of claim 43, further comprising an establishment module that establishes, prior to the providing the at least the subset of the set of promotional lottery tickets to the plurality of players in the promotional lottery game, a predetermined percentage of tickets sales to be paid in prizes won for the promotional lottery game and increasing each of the secondary prizes in the plurality of secondary prizes by an additional amount if the total percentage of actual ticket sales subtracted from the predetermined percentage of ticket sales results in a remainder, the additional amount being less than or equal to the remainder.

52. The system of claim 43, further comprising an establishment module that establishes, prior to the providing the at least the subset of the set of promotional lottery tickets to the plurality of players in the promotional lottery game, a predetermined percentage of tickets sales to be paid in prizes won for the promotional lottery game and increasing each of the predetermined minimum number of primary prizes by an additional amount if the total percentage of actual ticket sales subtracted from the predetermined percentage of ticket sales results in a remainder, the additional amount being less than or equal to the remainder.

53. The system of claim 43, further comprising establishing, prior to the providing the at least the subset of the set of promotional lottery tickets to the plurality of players in the promotional lottery game, a predetermined percentage of tickets sales to be paid in prizes won for the promotional lottery game and increasing each of the predetermined minimum number of primary prizes by a first additional amount in addition to increasing each of the secondary prizes in the plurality of secondary prizes by a second additional amount if the total percentage of actual ticket sales subtracted from the predetermined percentage of ticket sales results in a remainder, the total of the first additional amount and the second additional amount being less than or equal to the remainder.

54. The system of claim 43, further comprising a random selection module that randomly selects an additional distinct unique combination of the set of game digits from the predetermined number of unique combinations of the set of game digits.

55. The system of claim 54, further comprising a secondary prize distribution module that provides a secondary prize from the plurality of secondary prizes to a player if the player has a promotional lottery ticket with at least an ordered predetermined number of digits in the additional distinct unique combination of the set of game digits from the predetermined number of unique combinations of the set of game digits.

56. The system of claim 43, further comprising a sub-combination module that generates a predetermined number of unique sub-combinations of a set of game numbers such that each of the sub-combinations having the same quantity of numbers and randomly selecting a single subset of the set of game numbers that has the same quantity of numbers as each of the sub-combinations.

57. The system of claim 56, further comprising a printer that prints one of the unique sub-combinations of the set of game numbers on each promotional lottery ticket in the set of promotional lottery tickets.

58. The system of claim 57, further comprising a secondary prize distribution module that provides a secondary prize from the plurality of secondary prizes to a player based on a type of match on a promotional lottery ticket of the player between the unique sub-combination corresponding to the promotional lottery ticket and the single subset of the set of game numbers that is selected.

59. The system of claim 43, wherein the display module also indicates a predetermined number prize distribution that can be won with a promotional lottery ticket purchased after a first predetermined number of other promotional lottery tickets have been sold.

60. The system of claim 42, further comprising an establishment module that establishes, prior to the providing the at least the subset of the set of promotional lottery tickets to the plurality of players in the promotional lottery game, a predetermined percentage of tickets sales to be paid in prizes won for the promotional lottery game and increasing a quantity of primary prizes over the predetermined minimum number of primary prizes based on a remainder being greater than or equal to a primary prize in the predetermined minimum number of primary prizes, the remainder resulting from the predetermined percentage of ticket sales subtracted from the total percentage of actual ticket sales.

61. The system of claim 60, wherein the predetermined percentage of ticket sales is a percentage that generates enough revenue to equal costs of prizes in the promotional lottery.

62. The system of claim 61, further comprising a guarantee module that provides a guarantee for payment of at least a portion of at least some of the prizes in the promotional lottery.

63. The system of claim 42, further comprising an establishment module that establishes, prior to the providing the at least the subset of the set of promotional lottery tickets to the plurality of players in the promotional lottery game, a predetermined percentage of tickets sales to be paid in prizes won for the promotional lottery game and increasing a quantity of primary prizes over the predetermined minimum number of primary prizes based on a remainder being greater than or equal to two primary prizes in the predetermined minimum number of primary prizes, the remainder resulting from the predetermined percentage of ticket sales subtracted from the total percentage of actual ticket sales.

64. The system of claim 63, further comprising a guarantee module that provides a guarantee for payment of at least a portion of at least some of the prizes in the promotional lottery prior to the remainder.

65. The system of claim 42, further comprising a price category display module that indicates a first price category and a second price category from which one or more promotional lottery tickets can be purchased such that (i) the first price category corresponds to a first predetermined known quantity of one or more promotional lottery tickets and the second price category corresponds to a second predetermined known quantity of one or more promotional lottery tickets and (ii) a ratio of the second price category to the second predetermined quantity of one or more promotional lottery tickets is less than a ratio of the first price category to the first predetermined quantity of one or more promotional lottery tickets.

66. A system comprising:
a combination generation module that generates a predetermined number of unique combinations of a set of game digits, each of the combinations having the same quantity of digits;
a sub-combination module that generates a predetermined number of unique sub-combinations of a set of game numbers such that each of the sub-combinations having the same quantity of numbers and randomly selecting a single subset of the set of game numbers that has the same quantity of numbers as each of the sub-combinations;
a printer that prints a set of promotional lottery tickets for a promotional lottery game such that each of the promotional lottery tickets in the set of promotional lottery tickets corresponds to one of the unique sub-combinations of a set of game numbers and distinctly corresponds to one of the unique combinations of the set of game digits;
a display module that a predetermined minimum number of primary prizes and a plurality of secondary prizes, each of the secondary prizes in the plurality of secondary prizes having a lesser value than each of the predetermined minimum number of primary prizes;
a ticket distribution module that provides at least a subset of the set of promotional lottery tickets to a plurality of players in the promotional lottery game through ticket sales;
a primary prize random selection module that randomly selects, according to a predetermined number of iterations that equals the predetermined minimum number of primary prizes, a distinct unique combination of the set of game digits, in each iteration, from the combinations of the set of game digits appearing on the promotional lottery tickets in the subset of the set of promotional lottery tickets provided to the plurality of players in the promotional lottery game through ticket sales such that each of the predetermined minimum number of primary prizes is won in the promotional lottery game;
a secondary prize random selection module that randomly selects a single subset of the set of game numbers that has the same quantity of numbers as each of the sub-combinations;
a primary prize distribution module that provides each of the predetermined minimum number of primary prizes to each player with a distinct unique combination of the set of game digits from the combinations of the set of game digits appearing on the promotional lottery tickets in the subset of the set of promotional lottery tickets provided to the plurality of players in the promotional lottery game through ticket sales; and
a secondary prize distribution module that provides a secondary prize from the plurality of secondary prizes to a player based on a type of match on a promotional lottery ticket of the player between the unique sub-combination corresponding to the promotional lottery ticket and the single subset of the set of game numbers that is selected.

67. The system of claim 66, wherein each of the unique sub-combinations of a set of game numbers is selected by a player that purchases the promotional lottery ticket.

68. The system of claim 66, wherein each of the unique sub-combinations of a set of game numbers is randomly generated.

69. The system of claim 66, wherein a portion of the unique sub-combinations of a set of game numbers are selected by players that purchase promotional lottery tickets and a portion of the unique sub-combinations are randomly generated.

70. The system of claim 66, wherein the plurality of secondary prizes is a set of pari-mutuel based secondary prizes that are based on a predetermined portion of ticket sales.

71. The system of claim 66, wherein the indicating the plurality of secondary prizes is providing an estimate of each of secondary prizes in the plurality of secondary prizes.

72. The system of claim 66, further comprising an establishment module that establishes, prior to the providing the at least the subset of the set of promotional lottery tickets to the plurality of players in the promotional lottery game, a predetermined percentage of tickets sales to be paid for the secondary prizes won from the plurality of secondary prizes for the promotional lottery game.

73. The system of claim 72, further comprising a modification module that modifies each of the secondary prizes in the plurality of secondary prizes in relation to the estimate based on a number of winners of the secondary prizes in the plurality of secondary prizes and ticket sales volume.

74. The system of claim 66, further comprising an establishment module that establishes, prior to the providing the at least the subset of the set of promotional lottery tickets to the plurality of players in the promotional lottery game, a predetermined percentage of tickets sales to be paid in prizes won for the promotional lottery game and increasing each of the secondary prizes in the plurality of secondary prizes by an additional amount if the total percentage of actual ticket sales subtracted from the predetermined percentage of ticket sales results in a remainder, the additional amount being less than or equal to the remainder.

75. The system of claim 66, further comprising an establishment module that establishes, prior to the providing the at least the subset of the set of promotional lottery tickets to the plurality of players in the promotional lottery game, a predetermined percentage of tickets sales to be paid in prizes won for the promotional lottery game and increasing each of the predetermined minimum number of primary prizes by an additional amount if the total percentage of actual ticket sales subtracted from the predetermined percentage of ticket sales results in a remainder, the additional amount being less than or equal to the remainder.

76. The system of claim 66, further comprising an establishment module that establishes, prior to the providing the at least the subset of the set of promotional lottery tickets to the plurality of players in the promotional lottery game, a predetermined percentage of tickets sales to be paid in prizes won for the promotional lottery game and increasing each of the predetermined minimum number of primary prizes by a first additional amount in addition to increasing each of the secondary prizes in the plurality of secondary prizes by a second additional amount if the total percentage of actual ticket sales subtracted from the predetermined percentage of ticket sales results in a remainder, the total of the first additional amount and the second additional amount being less than or equal to the remainder.

77. The system of claim 66, further comprising an establishment module that establishes, prior to the providing the at least the subset of the set of promotional lottery tickets to the plurality of players in the promotional lottery game, a predetermined percentage of tickets sales to be paid in prizes won for the promotional lottery game and increasing a quantity of primary prizes over the predetermined minimum number of primary prizes based on a remainder being greater than or equal to a primary prize in the predetermined minimum number of primary prizes, the remainder resulting from the predetermined percentage of ticket sales subtracted from the total percentage of actual ticket sales.

78. The system of claim 77, wherein the predetermined percentage of ticket sales is a percentage that generates enough revenue to equal costs of prizes in the promotional lottery.

79. The system of claim 78, further comprising a guarantee module that provides a guarantee for payment of at least a portion of at least some of the prizes in the promotional lottery.

80. The system of claim 77, further comprising an establishment module that establishes, prior to the providing the at least the subset of the set of promotional lottery tickets to the plurality of players in the promotional lottery game, a predetermined percentage of tickets sales to be paid in prizes won for the promotional lottery game and increasing a quantity of primary prizes over the predetermined minimum number of primary prizes based on a remainder being greater than or equal to two primary prizes in the predetermined minimum number of primary prizes, the remainder resulting from the predetermined percentage of ticket sales subtracted from the total percentage of actual ticket sales.

81. The system of claim 80, further comprising providing a guarantee for payment of at least a portion of at least some of the prizes in the promotional lottery prior to the remainder.

82. The system of claim 77, further comprising a price category display module that indicates a first price category and a second price category from which one or more promotional lottery tickets can be purchased such that (i) the first price category corresponds to a first predetermined known quantity of one or more promotional lottery tickets and the second price category corresponds to a second predetermined known quantity of one or more promotional lottery tickets and (ii) a ratio of the second price category to the second predetermined quantity of one or more promotional lottery tickets is less than a ratio of the first price category to the first predetermined quantity of one or more promotional lottery tickets.
